(19) United States
(12) Patent Application Publication
(10) Pub. No.: US 2011/0231745 A1
(43) Pub. Date: Sep. 22, 2011

(54) SLIDESHOW CREATOR

(75) Inventors: Luc Levesque, Ottawa (CA); Rodney Boissinot, (US); Eric Lussier, (US)

(73) Assignee: TripAdvisor LLC., Newton, MA (US)

(21) Appl. No.: 13/047,681

(22) Filed: Mar. 14, 2011

Related U.S. Application Data
(60) Provisional application No. 61/314,077, filed on Mar. 15, 2010.

(51) Int. Cl. G06F 17/00

(52) U.S. Cl. 715/202

(57) ABSTRACT

Technology for creating slideshows is described. In various embodiments, the technology receives from a first client computing device, a request to create a slideshow; receives from the first client computing device an indication of a location of two or more content elements; retrieves from the indicated location the two or more content elements; identifies geographical locations associated with each of the retrieved two or more content elements; creates a slideshow containing the retrieved two or more content elements and at least one transition; and transmits a pointer to the created slideshow.

### CROSS-REFERENCE TO RELATED APPLICATIONS

This application claims the benefit of U.S. Provisional Application No. 61/314,077 entitled “SLIDESHOW CREATOR,” filed Mar. 15, 2010.

### BACKGROUND

Use of digital cameras is now commonplace. Digital cameras can be purchased as standalone units or integrated into other devices, e.g., mobile telephones, laptop computers, etc. People who travel (“travelers”), e.g., on vacation, often carry digital or film cameras with them to capture their memories in content elements, e.g., photographs, videos, etc. Whether they use digital cameras or film cameras, photographers (e.g., the travelers) sometimes share their images online. When using film cameras, they may scan their photographs (“photos”) into digital images before sharing the digital images.

People sometimes share photos they take in online photo albums (e.g., on Flickr®), blogs (e.g., TravelPod®), social networking (e.g., Facebook®), or other Web sites. However, these photos are generally statically displayed and viewers switch from one photo to the next manually or very simple visual transitions are provided.

### BRIEF DESCRIPTION OF THE DRAWINGS

FIG. 1 is a block diagram illustrating an environment in which the disclosed technology may operate in some embodiments.

FIG. 2 is a block diagram illustrating some details of a server computing device employed by the disclosed technology in various embodiments.

FIG. 3 is a block diagram illustrating some details of a client computing device employed by the disclosed technology in various embodiments.

FIG. 4 is a flow diagram illustrating a routine invoked by the disclosed technology in some embodiments.

FIG. 5 is a flow diagram illustrating a routine invoked by the disclosed technology in some embodiments to identify geographical attributes.

FIG. 6 is a block diagram illustrating contents of a template employed by the disclosed technology in various embodiments.

FIG. 7 is a flow diagram illustrating a routine invoked by the disclosed technology in some embodiments to enable a creator of a slideshow to access additional templates.

FIG. 8 is a user interface diagram illustrating aspects of a user interface provided by the disclosed technology in various embodiments.

FIGS. 9-51 are user interface diagrams illustrating user interfaces relating to creating and displaying slideshows created with the disclosed technology in various embodiments.

### DETAILED DESCRIPTION

The disclosed technology is generally directed to creating improved slideshows that have a superior production quality than static slideshows. These improved slideshows may have various multimedia elements, e.g., video, audio, animation, etc. In some embodiments, a user identifies content (e.g., photos, videos, etc.) and the disclosed technology automatically assembles a slideshow. The slideshow can include an introductory animation, maps (e.g., of travel destinations), flags (e.g., of the countries visited), the user's photos and/or videos, credits, passport stamps, music, etc. In various embodiments, the user (“creator”) can select templates to use when constructing the slideshow, specify the travel destinations where the photos and/or videos were captured, and share the created slideshow with others (“viewers”). In various embodiments, videos can optionally include still images and/or audio content.

In some embodiments, the disclosed technology can operate with content (e.g., photos and/or videos) stored at a client computing device. As an example, after returning from a trip, the creator may store content on the creator's home computer. In some embodiments, the disclosed technology can operate with content stored online (e.g., a social networking Web site).

To create a slideshow, the creator can navigate a Web browser to a server (“Web service”), identify the location of the content, and request a slideshow to be created. The Web service can then copy the selected content to a server, identify attributes (e.g., geographical locations) to associate with the uploaded content, and automatically assemble a slideshow without any further input from the creator. The Web service may add maps and flags associate with the identified geographical locations. In the maps, the Web service may identify (e.g., by placing pushpins or other identifying notations) associated with a sequence of content. Suppose the creator traveled from Ottawa to New York; then from New York to Lima, Peru; and finally returned to Ottawa via the reverse path, and took photos at each geographical location. The Web service may initially identify Ottawa as the geographical location for all of the photos by looking up the user's Internet Protocol (“IP”) address using an IP lookup registry service. Alternatively, the Web service may enable the user to specify which photographs correspond with which geographical locations. Alternatively, the Web service may employ geo-location tags stored in metadata associated with the photographs. The Web service may then assemble the photographs (e.g., using flyover effects or other animation techniques) along with other multimedia content specified by a template into a slideshow. The additional multimedia content can include maps of the visited geographical locations, music (e.g., music from the visited geographical locations or generic music for the entire slideshow), passport stamps from visited countries, etc. The maps may include an animated sequence, e.g., showing pushpins being added to denote an order in which the user visited the geographical locations. The Web service may then give the user the option of downloading the slideshow in a multimedia file format (e.g., Adobe Flash, Windows® Media, etc.), storing it at a server (e.g., YouTube®), and/or sharing it with viewers.

The assembled slideshow can contain an introductory sequence, maps showing the visited geographical locations, flags associated with the geographical locations, the creator's content, credits, and/or other content. The slideshow is assembled as a highly stylized, professional-quality multimedia presentation. As an example, the introductory sequence can give the viewer the perspective of flying through clouds, and the maps can have an ethereal quality. Text for the introduction can include a name for the slideshow (e.g., a name specified by the creator and/or including the creator's name). Text for the credits can include the creator's name, advertiser's names, the Web service's name, etc. The text for the introduction, credits, and content can be provided by the user initially before the slideshow is created or later. As an example, the Web service may initially assign all textual and geographical location information. The creator can thereafter add and/or revise the information the Web service initially assigned.

In some embodiments, the Web service may be able to automatically identify text for content based on metatdata, text associated at the social networking site from which the content was copied, etc. As an example, photographers sometimes add caption information to photographs that is stored in metadata associated with the photographs. Social networking site users sometimes identify or “tag” people who appear in photographs. The Web service may be able to use this information to display caption information when a photograph or video is displayed.

In some embodiments, the Web service may function with other Web sites or services to provide additional information. As an example, the Web service may function with the Expedia® travel site to identify geographical locations based on the user's travel schedule. Digital cameras and videocameras commonly place date and time stamps in the metadata of photographs and videos. The Web service may determine geographical location based on the creator's confirmed travel itinerary stored in Expedia®. As another example, the Web service may function with image or face detection Web sites so that once a person or item is identified in one photograph or video, the same person or item is automatically identified in other photographs or videos for displaying of captions. As another example, when an album is imported from Facebook®, the Web service may import the album name, tags associated with photos, etc., to automatically populate the introductory sequence, content captions, etc.

In some embodiments, the creator is able to select from an additional set of templates after the creator has shared a slideshow with a threshold number of viewers. As an example, the Web service may initially provide a limited number of templates the creator can select from. After the creator has created one or more slideshows and then shares the created slideshow with ten viewers, the Web service may enable the creator to select from one or more additional templates.

The templates can define content and a sequence of events for slideshows. Each template can include different introductory sequences, colors, animations, transitions for the creator's content, music, credits, map styles, etc. As an example, a template may initially display a passport and then display a page from the passport that in turn displays passport stamps from every country the creator has visited (and possibly where the creator has captured content). A “camera angle” for the slideshow animation then follows a line emanating from the passport page that progresses over an ocean, mountain, and clouds, and then approaches a three-dimensional pin on a map. After the pin is seemingly struck by the camera, a number of photos are displayed in an explosive effect around the pin. As an example, one photo may be displayed for each country that was visited. Alternatively, the slideshow may progress from country to country, wherein each line emanating from the passport page and striking a map pin is for each visited country. The slideshow could then display photos taken in each country, accompanied with background music. The background music can continue for the entire slideshow or change for each country (e.g., the music can be associated with the country whose photos are presently being viewed by the viewer).

Thus, the slideshow the Web service creates is a high-production-value animation akin to an online movie and not a sequence of static images, and unlike online photo albums that are commonly available today.

The creator can share the created slideshow by sending via electronic mail (“email”) a link to the slideshow, embedding the slideshow in a blog or other Web site, etc. In some embodiments, the slideshow may be accompanied by code in a markup language (e.g., HTML) that allows the creator to embed the slideshow in another Web site. In various embodiments, the code may provide a link to another Web site (e.g., a travel-related blog site such as TravelPod.com.) An example of such a link is provided below:

<div
style=“width:420px;padding:0;margin:0;border:none;background:#
000”><embed width=“420” height=“272”
src=“http://www.travelpod.com/bin/app/flash/app.swf?t=237f3c42
” flashvars=“xmlPath=%2Fapp%2Ftp-0000-dae8-1f2d%2Fapxml%3Fso”
base=“http://www.travelpod.com/bin/app/flash/”
type=“application/x-shockwave-flash” quality=“high”
bgcolor=“#000000” name=“App” wmode=“opaque”
pluginspage=“http://www.macromedia.com/go/getflashplayer”
allowscriptaccess=“always” allowfullscreen=“true” /><!-- Use
of this widget is subject to the terms stated here:
http://www.travelpod.com/help/widget_terms --><div
style=“width:420px;padding:0;margin:0;border:none;background:#
fff;font-family:verdana,sans-serif/color:#999;text-
align:justify;font-size:9px”>This travel slideshow of John
Smith&rsquo;s trip to 13 cities including <a
href=“http://www.travelpod.com/travel-blog-
city/France/Paris/tpod.html” style=“color:#c60”>Paris</a>, <a
href=“http://www.travelpod.com/travel-blog-
city/Italy/Rome/tpod.html” style=“color:#c60”>Rome</a> and <a
href=“http://www.travelpod.com/travel-blog-
city/Germany/Berlin/tpod.html” style=“color:#c60”>Berlin</a>
was created by TravelPod the Web&rsquo;s First <a
href=“http://www.travelpod.com” style=“color:#c60”>Travel
Blog</a> on Friday, March 12, 2010 at 7:10pm UTC. John
traveled 14,173 kilometers (8,807 miles) on this
trip.</div></div>

When the creator adds this code to a Web site, the created slideshow is embedded. Moreover, a viewer sees text describing the trip the slideshow relates to. If the viewer clicks on a link associated with the slideshow and/or text, the viewer is taken to a travel-related blog (e.g., TravelPod®).

In some embodiments, the Web service does not require creators to register with the Web site. Requiring users to register before they take advantage of functionality a Web site offers is sometimes seen as discouraging use. Indeed, some studies have shown that some users simply navigate their Web browser to another Web site when a Web site they are visiting requires registration. To avoid requiring creators to register to create a slideshow, the Web service enables creators to create slideshows anonymously. After the slideshow is created, the Web service asks creators if they would like to ever edit the slideshow again. If they respond positively, the Web service requests the creators to provide their email address. The Web service then transmits a link in an email message which the creators can subsequently select to edit the slideshow in the future. By functioning in this manner, the Web service removes friction associated with registration. Moreover, the Web service can later be co-branded with another Web service or Web site without requiring common user sign-in credentials. In various embodiments, users may need to register by providing an email address, login credentials, social networking name/credentials, etc. before being able to save their slideshow for future editing. As an example, the technology may employ a FACEBOOK application program interface (API) to enable the user to log in via FACEBOOK (or other social networking website) before saving the slideshow for future editing or even for sharing, e.g., via the social networking website.

In various embodiments, the Web service transmits a client-side multimedia file (e.g., Adobe Flash file). By transmitting a client-side multimedia file instead of a streamed multimedia file, a viewer is given additional control capabilities. When viewing a streamed multimedia file, a viewer is generally only able to pause, rewind, and fast-forward the content. In contrast, a client-side multimedia file can enable a user to a larger version of an interesting photograph, navigate the photographs in a manner of the viewer's choosing (e.g., by clicking on points along a timeline or map), etc.

Some online slideshows render the video on the server then played as a video via flash. We generate the slideshow as an interactive, client side, flash movie. This means that the client PC does all of the processing instead of the server BUT it also means that the slideshow can be more interactive. For instance, in our slideshows you can click a photo to see a larger version of it. If the slideshow was generated server side as a movie, this would not be possible.

In some embodiments, the disclosed technology may automatically add music to a slideshow. As an example, the technology may add music that is based on the geographical locations at which the photographs and/or videos were captured. As an example, if a user visited two different countries during a trip, the disclosed technology may display a slideshow with photographs and/or videos from the first country, a transition, and then photographs and/or videos from the second country; and may select and play music from each of the countries while a viewer is viewing the slideshow from those countries. The disclosed technology may select music from countries, regions, cities, etc. based on identified geographical locations, geo-tags, etc. In some embodiments, the technology may create the music automatically; and in other embodiments, the technology may retrieve music, e.g., from a server. In various embodiments, the technology may add the music during creation of the slideshow or during playback of the slideshow. As an example, when a traveler includes photographs from Canada, Ireland, and India in a slideshow, the technology may add as background music Canadian music for the photographs taken in Canada, Irish music for the photographs taken in Ireland, and Indian music for the photographs taken in India. The technology may also automatically add transitions, which can be musical interludes, fading one music into the other, etc.

In various embodiments, the technology can retrieve data for use in the slideshow from various sources including, e.g., data associated with photographs, social networking websites, hometowns identified by social networking website users, IP locations from which photographs are uploaded, etc.

In various embodiments, the technology may include an annotated “location” indicator on a navigational slider that enables viewers to jump to a specific spot in an animation sequence or slideshow based on the location that the creator of the slideshow indicated as the origin (or other locations) of the photos. As an example, the navigational slider may include a sequence of cities the creator of the slideshow visited, and the viewer may slide the slider to a particular city to view photographs from that city.

Several embodiments of the facility are described in more detail in reference to the Figures. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection. The network links may be wired or wireless (e.g., radio-frequency based or optical).

Although not required, aspects and embodiments of the disclosed technology will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor or any device capable of communicating with a network, including consumer electronic goods such as game devices, cameras, or other electronic devices having a processor and other components, e.g., network communication circuitry.

The disclosed technology can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the disclosed technology described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the disclosed technology may reside on a server computer, while corresponding portions reside on a client computer. Data structures and transmission of data particular to aspects of the disclosed technology are also encompassed within the scope of the invention.

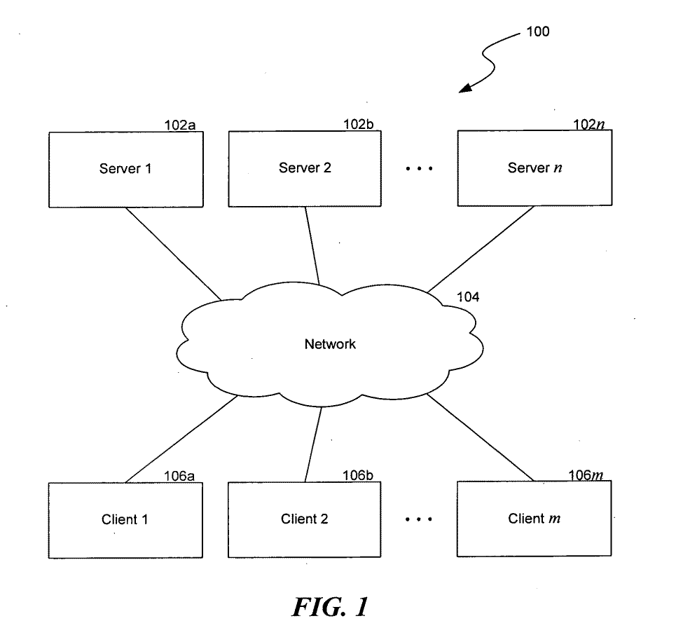

FIG. 1 is a block diagram illustrating an environment in which the disclosed technology may operate in some embodiments. The environment 100 can include one or more server computing devices connected via a network to one or more client computing devices. As an example, the environment 100 can include server 1 102a, server 2 102b, up to server n 102n. The servers may be interconnected, e.g., via a network 104. The network 104 can be the Internet, one or more intranets, or a combination of the Internet and one or more intranets. The environment 100 can also include client 1 106a, client 2 106b, up to client m 106m. the client can connect with the servers via the network 104.

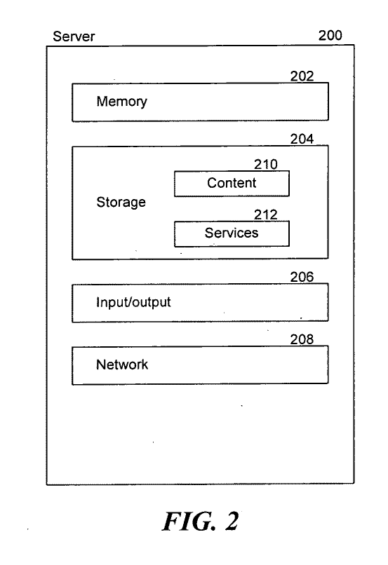

FIG. 2 is a block diagram illustrating some details of a server computing device employed by the disclosed technology in various embodiments. The server 200 can include various components, e.g., a computer readable medium (e.g., memory 202), storage 204, input and/or output 206, and network 208. The storage can be a volatile or non-volatile storage (e.g., memory, hard disk, optical disk, etc.). The storage can additionally include content 210 and services 212. As examples, content can be documents in a markup language (e.g., HTML), photographs, videos, multimedia content, databases, etc. Services can include Internet servers, mapping servers, streaming media servers, social networking servers, etc. As is known in the art, a Web service comprises a server, one or more of the illustrated components, and other components (not illustrated). As is also known in the art, some Web services can employ the services of other Web services to provide a common service. Alternatively, a client application may employ the services of one or more Web services (sometimes called a “mashup”). Although a single one of each component is illustrated, the server can have one or more of each component.

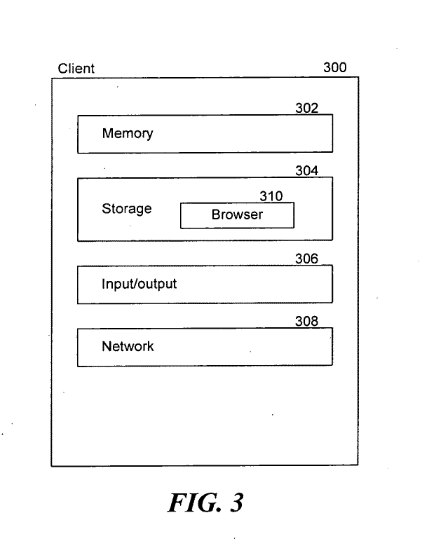

FIG. 3 is a block diagram illustrating some details of a client computing device employed by the disclosed technology in various embodiments. The client 300 can include various components, e.g., a computer readable medium (e.g., memory 302), storage 304, input and/or output 306, and network 308. The storage can be a volatile or non-volatile storage (e.g., memory, hard disk, optical disk, etc.). The storage can additionally include a Web browser 310 or other client application. As examples, content can be documents in a markup language (e.g., HTML), photographs, videos, multimedia content, databases, etc. Services can include Internet servers, mapping servers, streaming media servers, etc. Although a single one of each component is illustrated, the client can have one or more of each component.

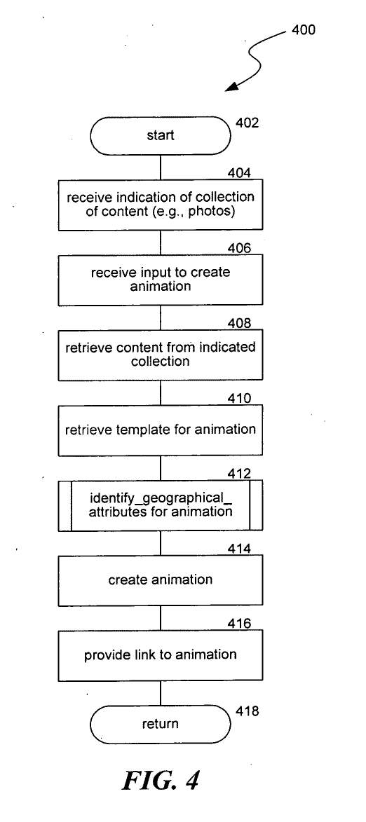

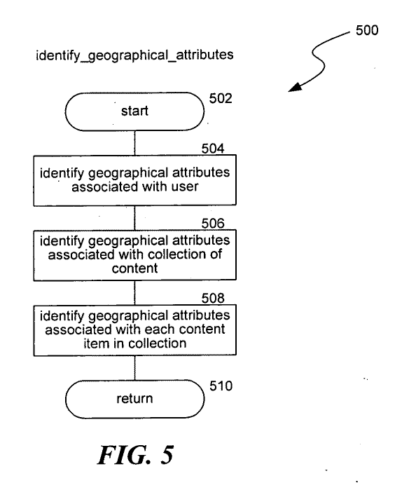

FIG. 4 is a flow diagram illustrating a routine invoked by the disclosed technology in some embodiments. The routine 400 begins at block 402. At block 404, the routine receives an indication of a collection of content. In various embodiments, the collection of content can be photographs, videos, text, images, or any multimedia content. The indication of the collection can be a location on a computer, a network location, a uniform resource locator, a Facebook® album, a Flickr® album, etc. At block 406, the routine receives input from a creator to create an animation (e.g., slideshow). At block 408, the routine retrieves content from the indicated collection. As an example, the routine may copy photographs from an online photo album, a network location, hard disk, optical disk, etc. At block 410, the routine retrieves a template for use during creation of the animation. At block 412, the routine invokes a subroutine to identify geographical attributes. The subroutine is described in further detail below in relation to FIG. 5. At block 414, the routine creates and stores an animation. At block 416, the routine provides a link to the animation. In various embodiments, the creator can download the animation, forward the link to others, store the link, etc. At block 418, the routine returns.

Those skilled in the art will appreciate that the logic illustrated in FIG. 4 and described above, and in each of the flow diagrams discussed below, may be altered in a variety of ways. For example, the order of the logic may be rearranged, substeps may be performed in parallel, illustrated logic may be omitted, other logic may be included, etc.

FIG. 5 is a flow diagram illustrating a routine invoked by the disclosed technology in some embodiments to identify geographical attributes. The routine 500 begins at block 502. At block 504, the routine identifies geographical attributes associated with the user (e.g., creator). As examples, the geographical attributes can be a geographical location the user identified while registering with the Web service; a geographical location that can be identified based on an Internet Protocol (“IP”) address associated with the client computing device the user is presently using, the user's stored travel itinerary, etc. At block 506, the routine identifies geographical attributes associated with the collection of content the user identified. As an example, the geographical attributes can be based on a city identified in association with the collection, e.g., as an attribute of an online photo album. At block 508, the routine identifies geographical attributes associated with each content item in the collection. As an example, the geographical attributes may be found in metadata stored in association with each content item, e.g., as a geo-encoded location. Some digital cameras store longitude and latitude information for each photograph based on GPS or other geo-location information. The Web service may then identify a city or other geographical location based on this geo-location information. The routine returns at block 510.

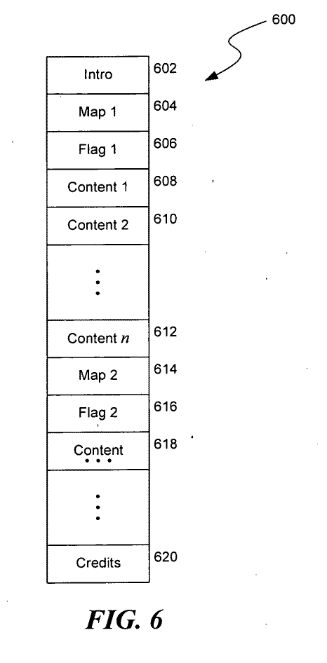

FIG. 6 is a block diagram illustrating contents of a template employed by the disclosed technology in various embodiments. A server may store one or more templates and a user may be provided access to a subset of these templates. The template 600 can include content (e.g., the content itself, pointers to the content, identifications of storage locations for the content, etc.). As examples, the template can identify an introductory sequence 602, a first map 604, the first flag 606, and user-identified content 608, 610, and 612. When the user has traveled to multiple geographical locations, the template 600 may additionally include a second map 614, a second flag 616, and additional a user-identified content 618. The template 600 may also include credits 620. In various embodiments, the templates are used to populate slideshows using other multimedia content stored at one or more servers. As examples, the maps and flags may be identified based on the geographical locations associated with the user-defined content.

In various embodiments, segments of a slideshow can include photo sequence styles (e.g., flip photos, rotating photos, etc); music; background effects (e.g., animations, blurred photos going by, etc.), video clips, etc. By combining these segments, the Web service can create unique sequences.

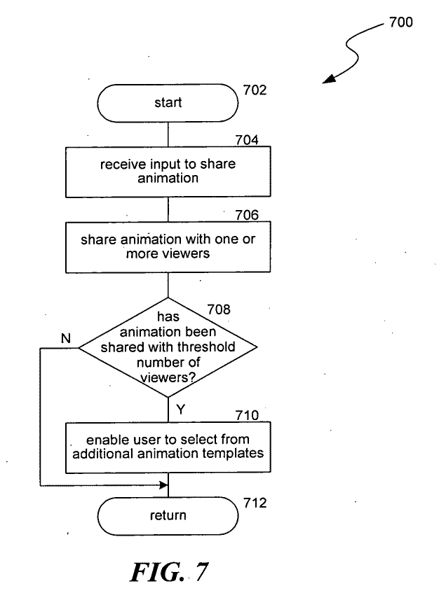

FIG. 7 is a flow diagram illustrating a routine invoked by the disclosed technology in some embodiments to enable a creator of a slideshow to access additional templates. The routine 700 begins at block 702. At block 704, the routine receives input to share an animation (e.g., slideshow). At block 706, the routine shares the identified animation with one or more viewers, e.g., by sending a link to the animation to the identified viewers. The routine updates a storage identifying the number of times the creator has shared animations (not illustrated). At decision block 708, the routine determines whether the creator has shared animations with more than a threshold number of viewers. If the creator has shared animations with more than the threshold number of viewers, the routine continues at block 710. Otherwise, the routine returns at block 712. At block 710, the routine enables the creator to select from additional animation templates that the creator could not previously select.

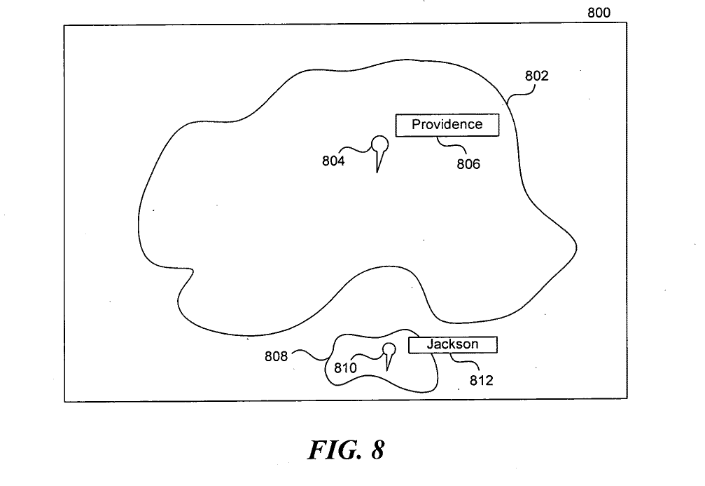

FIG. 8 is a user interface diagram illustrating aspects of a user interface provided by the disclosed technology in various embodiments. An output device 800 can display a map of a first geographical location 802 and a map of a second geographical location 808. The map 802 can include a pin 804 at a specific location on the map and a label 806 identifying the specific location. The map 808 can include a pin 810 at a specific location on the map and a label 812 identifying the specific location. The map can also indicate a line (not illustrated) from a first location (e.g., at pin 804) to a second location (e.g., at pin 810) to signify that the creator traveled from the first location to the second location. The line may be animated in some embodiments.

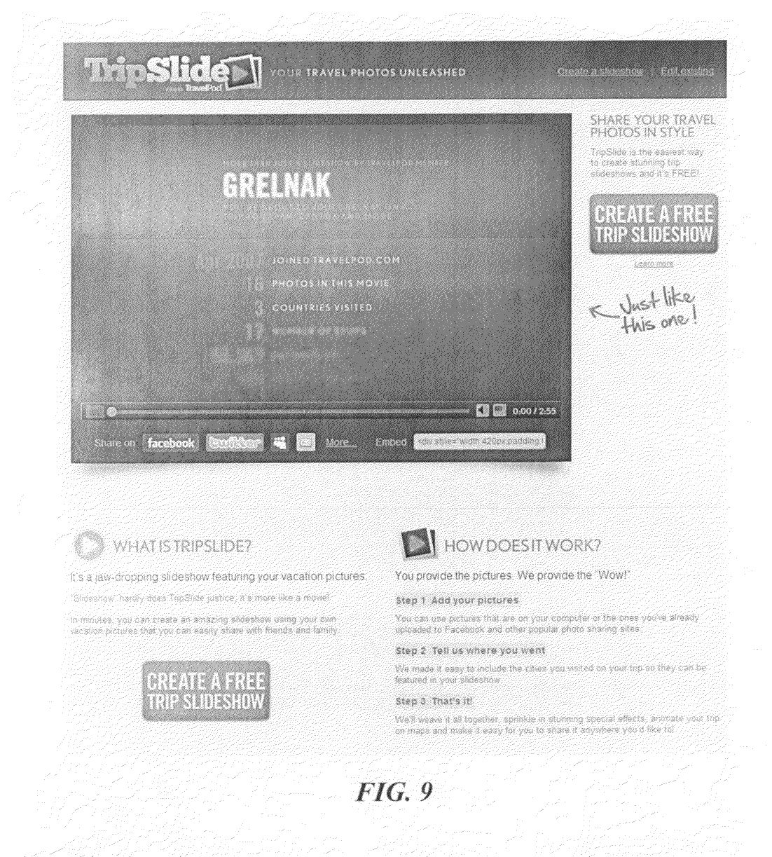

FIGS. 9-44 are user interface diagrams illustrating user interfaces relating to creating and displaying slideshows created with the disclosed technology in various embodiments.

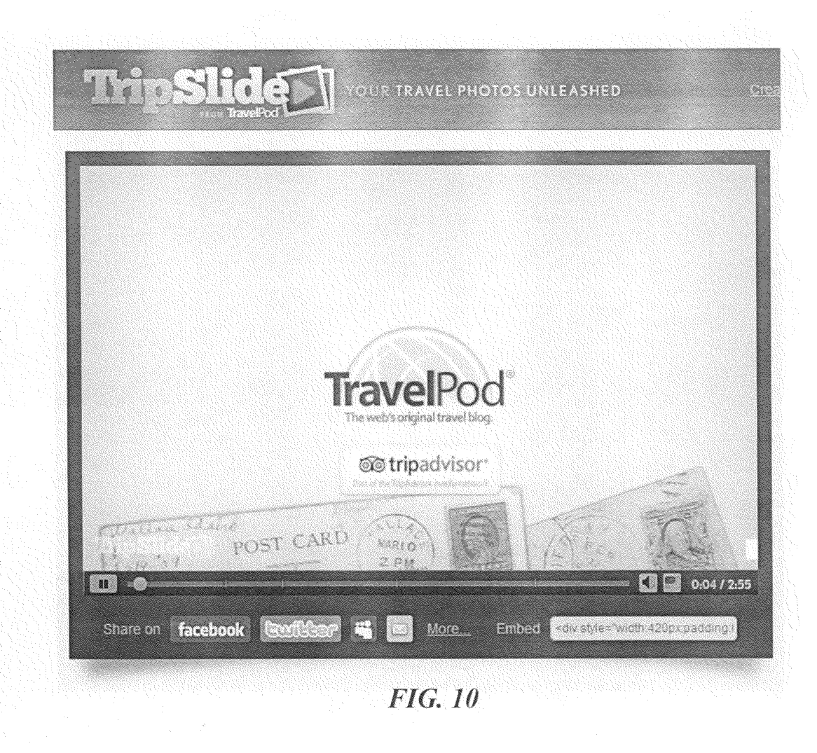

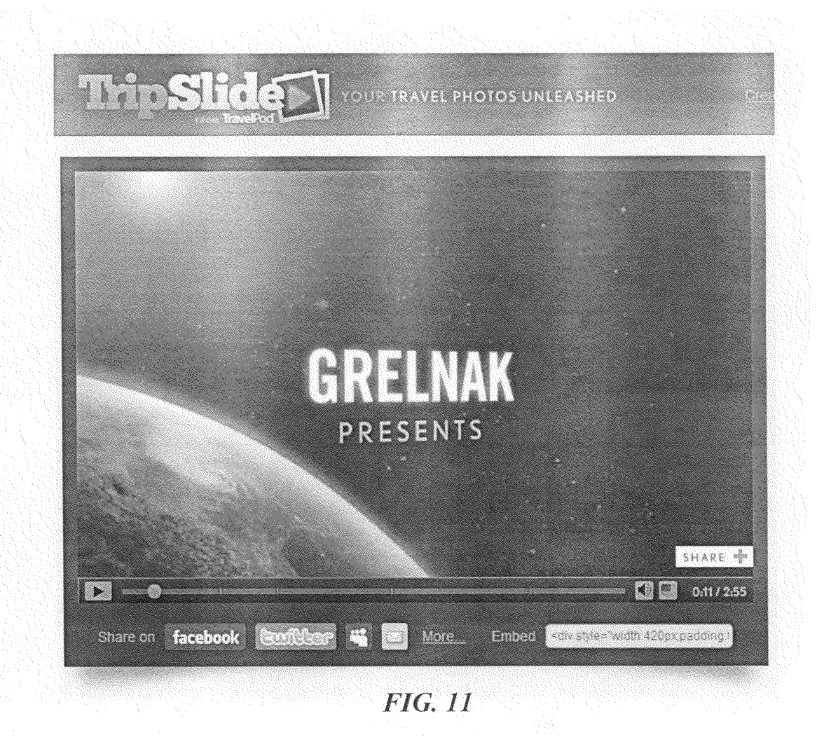

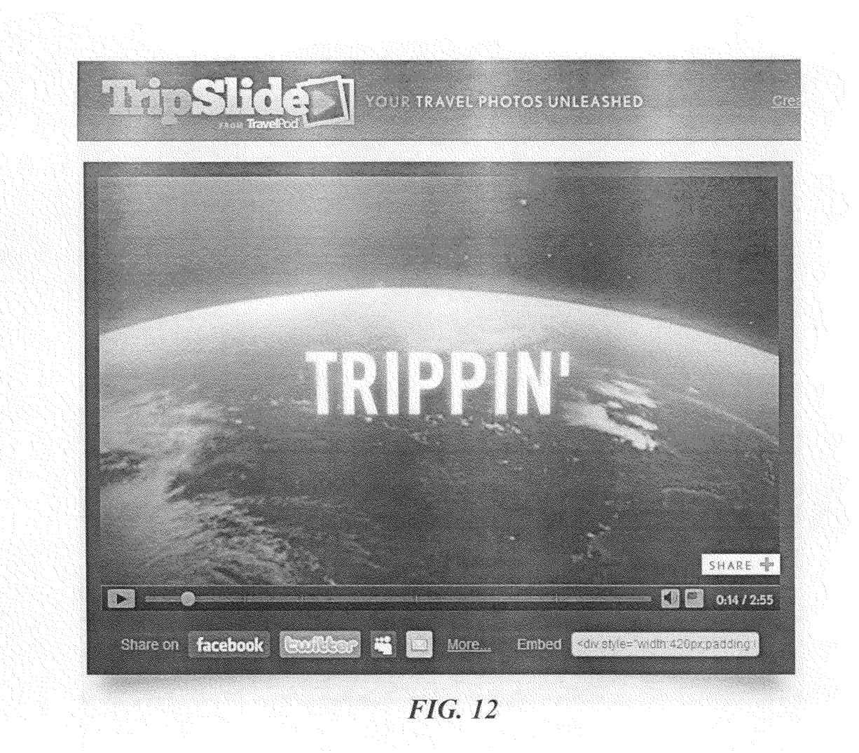

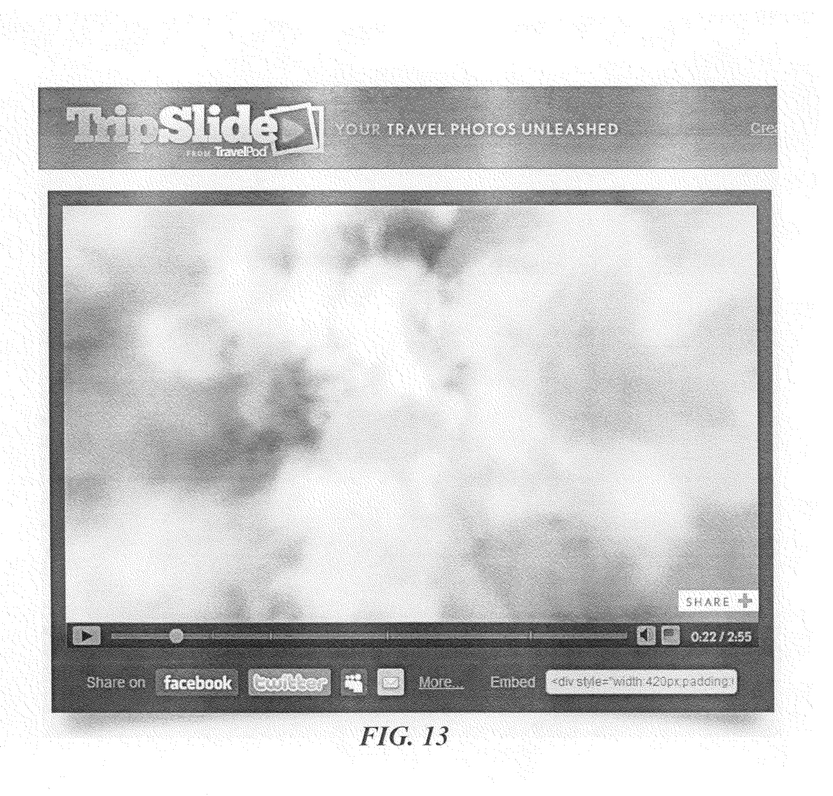

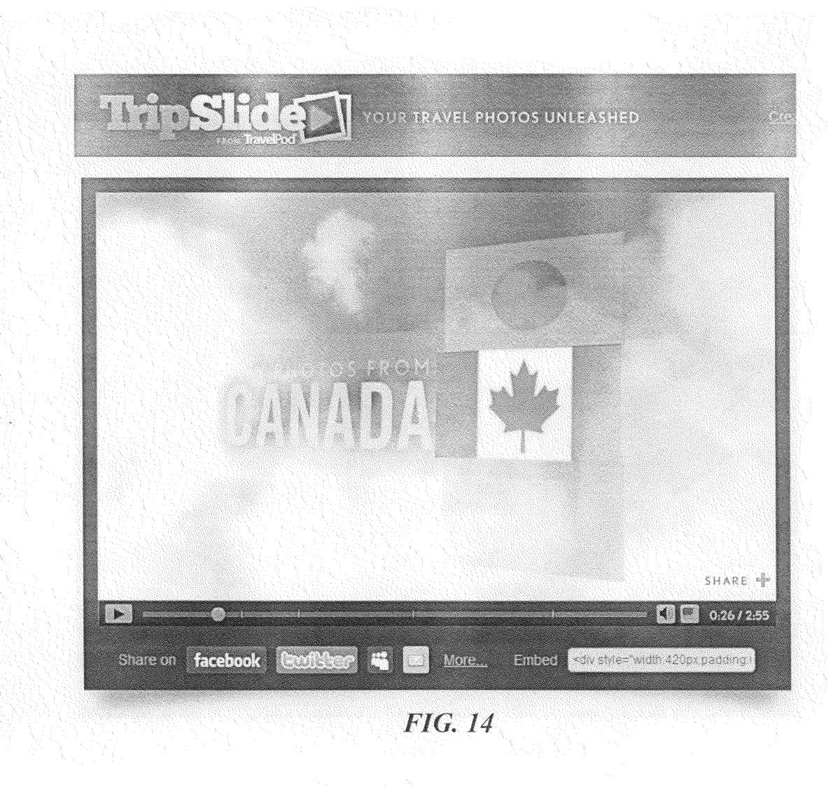

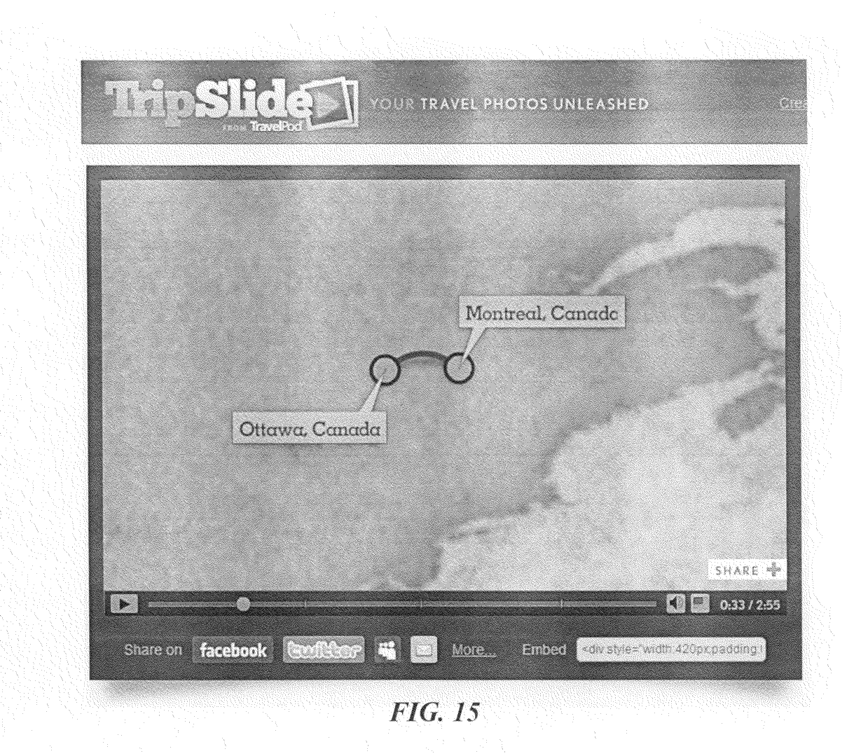

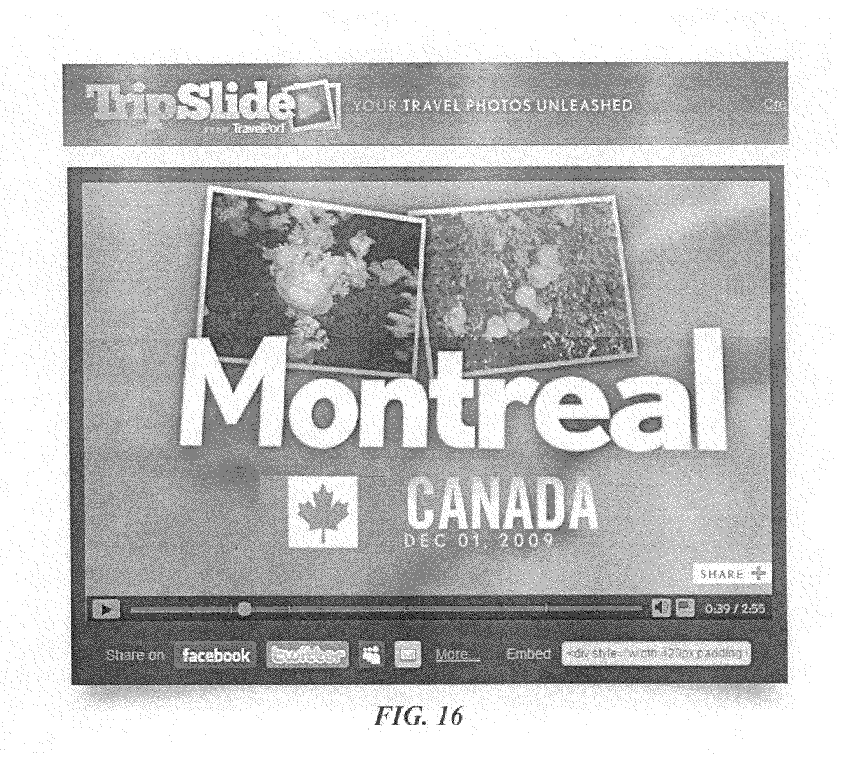

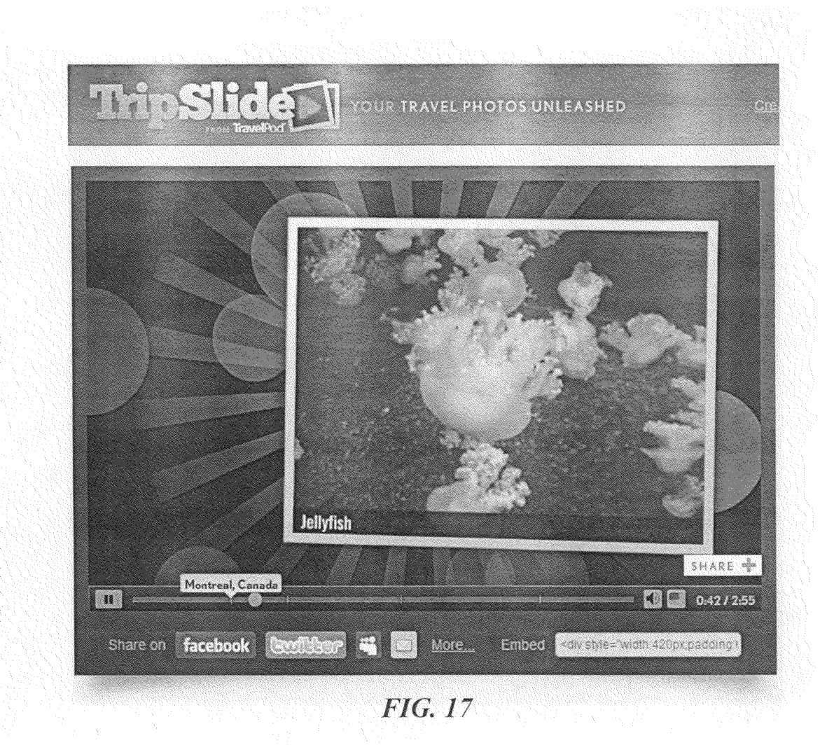

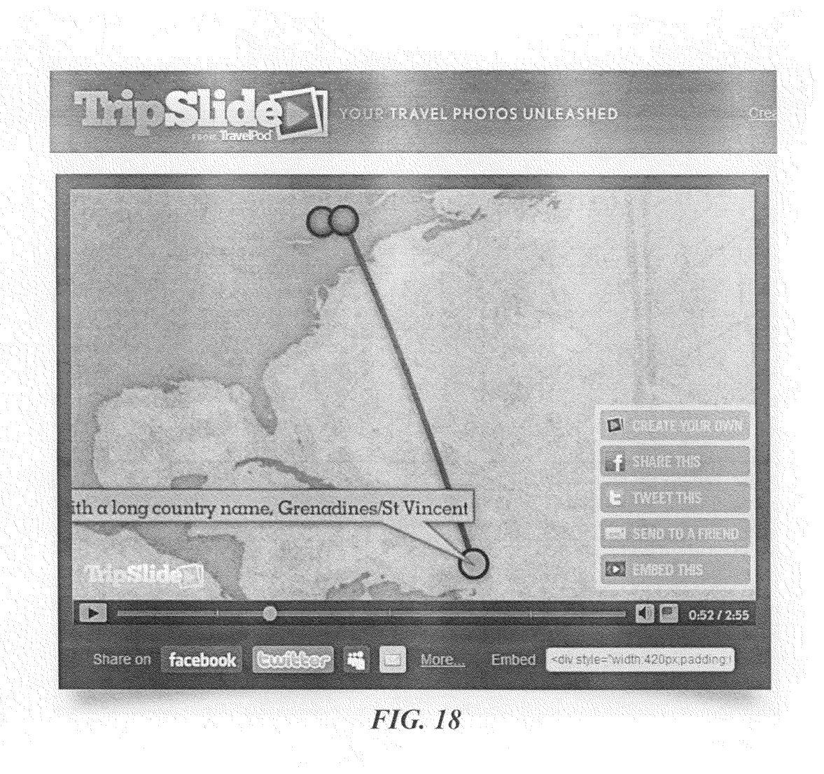

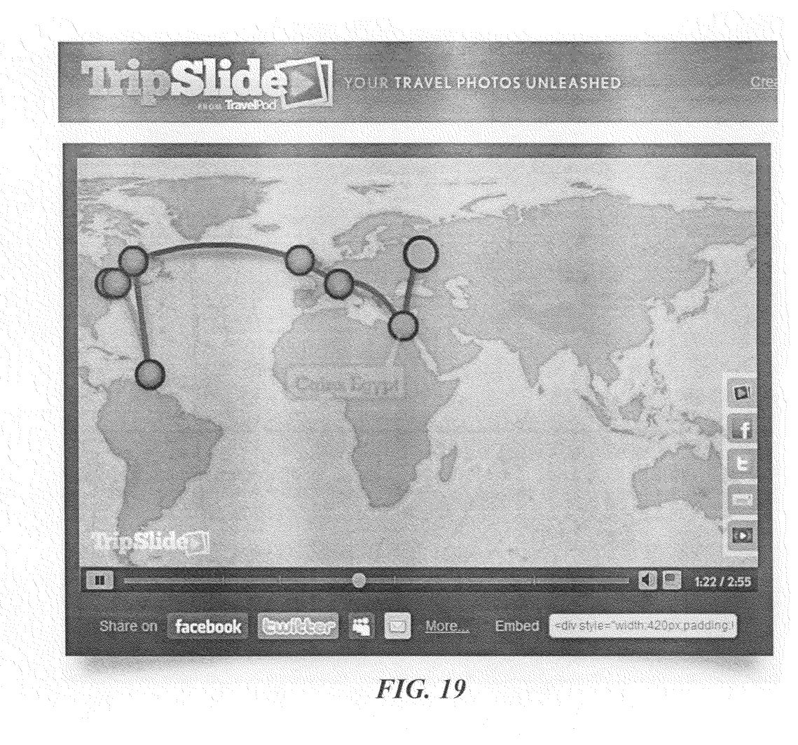

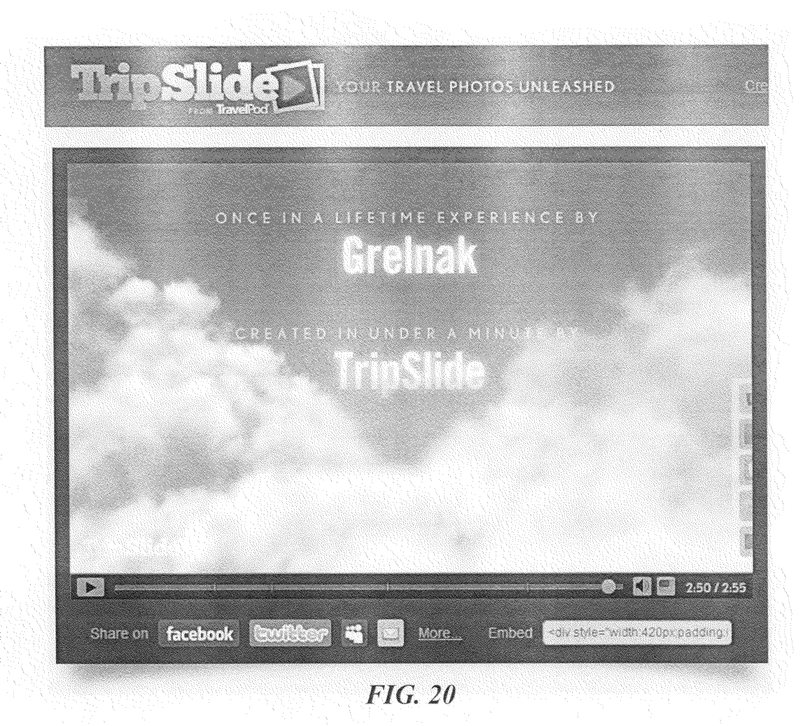

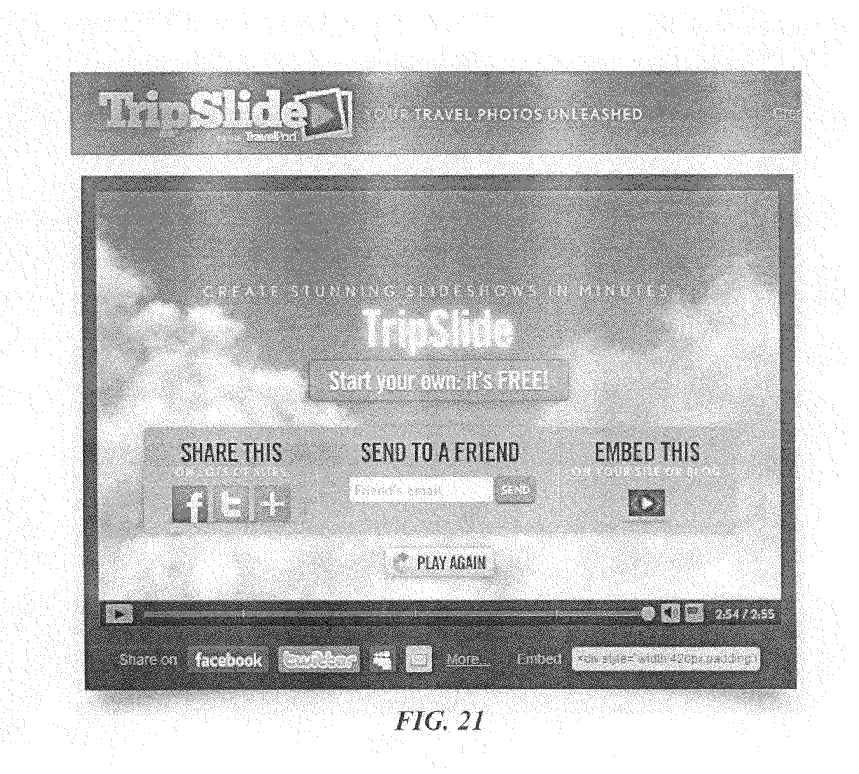

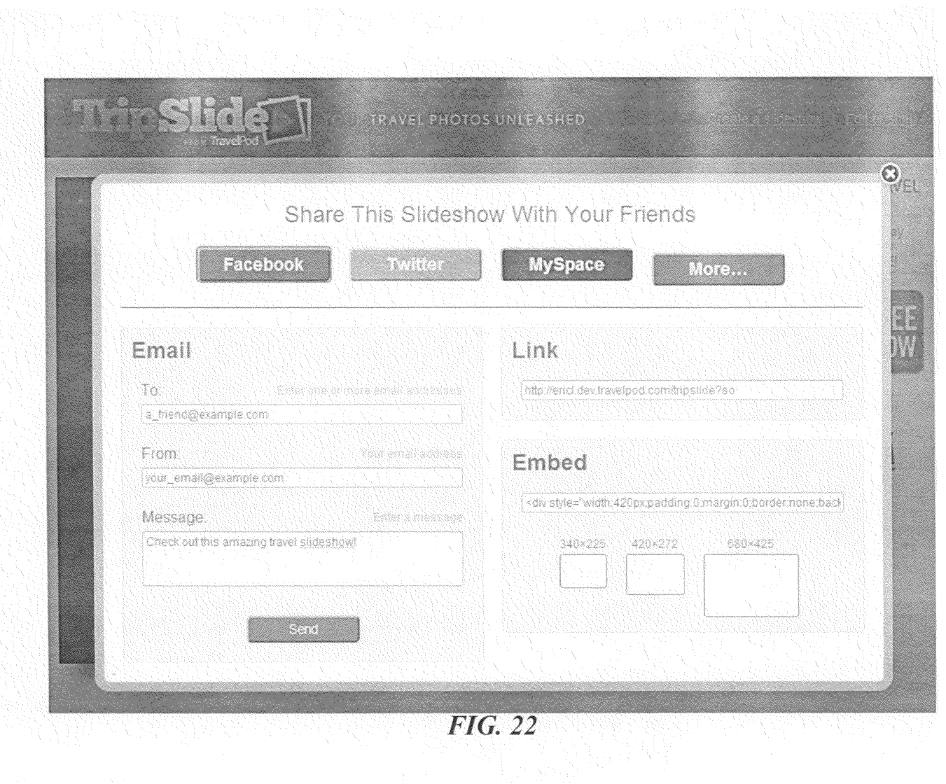

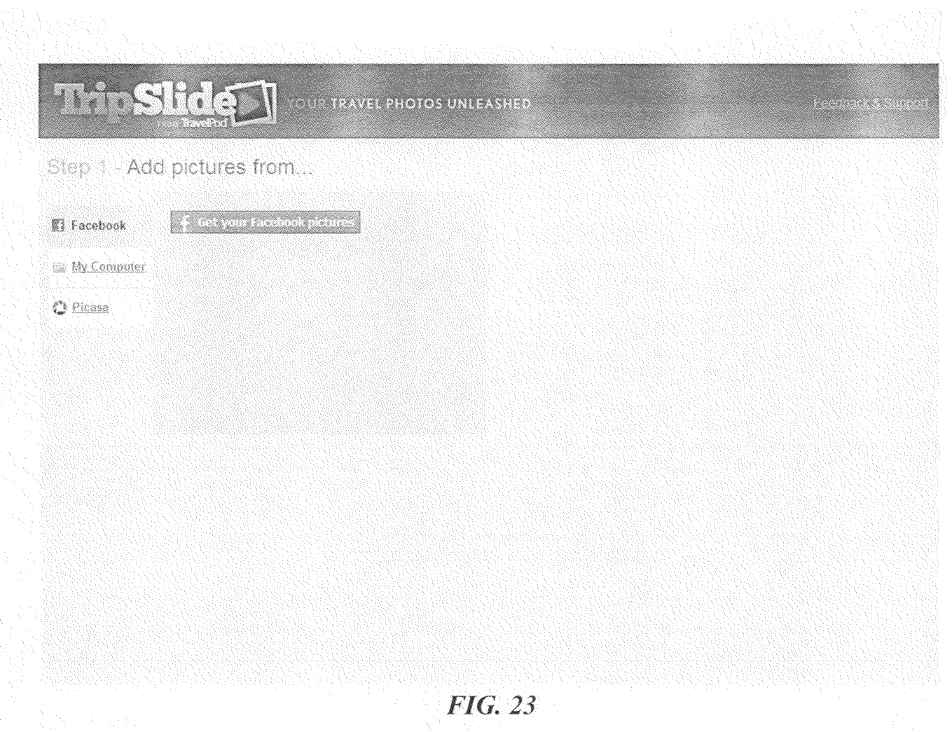

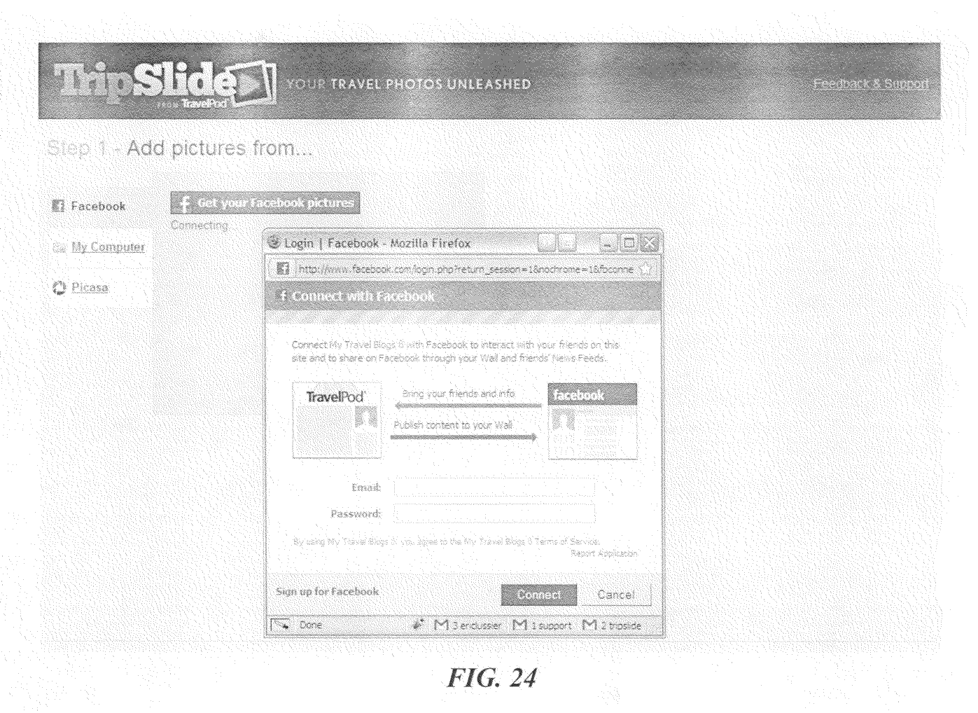

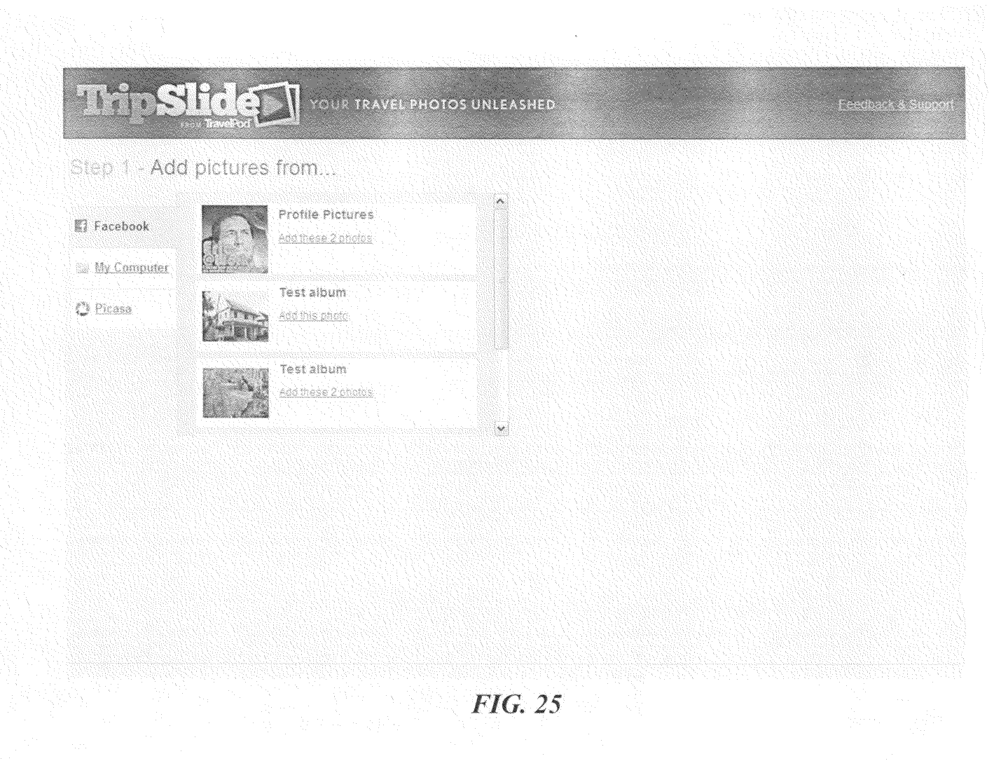

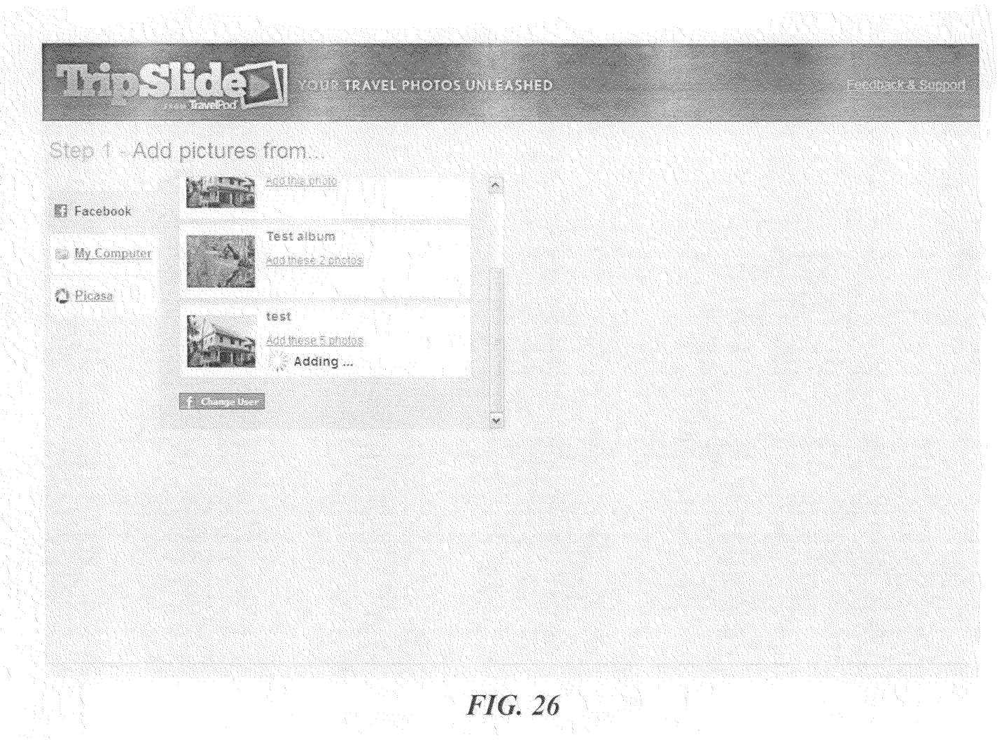

FIG. 9 illustrates an introductory slide that explains to users how to use a slideshow creator. FIG. 10 illustrates a “splash screen” that may appear at the beginning of a slideshow. FIG. 11 illustrates an introductory slide. The technology may automatically add background slide elements, e.g., videos, images, music, etc. FIG. 12 illustrates an introduction that a user may add to the slideshow. FIG. 13 illustrates a transitional slide, e.g., offering a cinematic, professionally created experience. FIG. 14 illustrates a transitional slide, e.g., displaying a map or flag of a country in which a following sequence of slides may have been taken. FIG. 15 illustrates a slide showing a map with multiple geographical locations that a user may have visited during the trip. FIG. 16 illustrates a slide introducing a next geographical location during the slideshow. FIG. 17 is a slide illustrating a photograph that a user may have taken at the geographical location. FIG. 18 is a slide illustrating a map indicating a next geographical location that the user may have visited. FIG. 19 is a slide illustrating a sequence of geographical locations that the user may have visited. The technology may have determined the sequence, e.g., based on timestamps in metadata associated with the photographs. FIG. 20 is a slide illustrating a conclusion to the slideshow. FIG. 21 is a slide that the technology may employ to “virally” market the slideshow creator. FIG. 22 is a screenshot that the technology may provide to a user who desires to share the slideshow the technology created. As examples, the technology may enable e-mailing the slideshow, linking the slideshow, or embedding the slideshow in a webpage. FIG. 23 is a screenshot illustrating enabling the user to retrieve photographs from a social networking website. FIG. 24 is a screenshot illustrating enabling the user to interact with the social networking website, e.g., to publish or share the slideshow. FIG. 25 is a screenshot illustrating enabling the user to select photographs from multiple sources in which the user's photographs may be stored. FIG. 26 is a screenshot illustrating a progress indicator that may be displayed when photographs are being added to a slideshow. In various embodiments, the slideshow creator may execute at a client device or a server device.

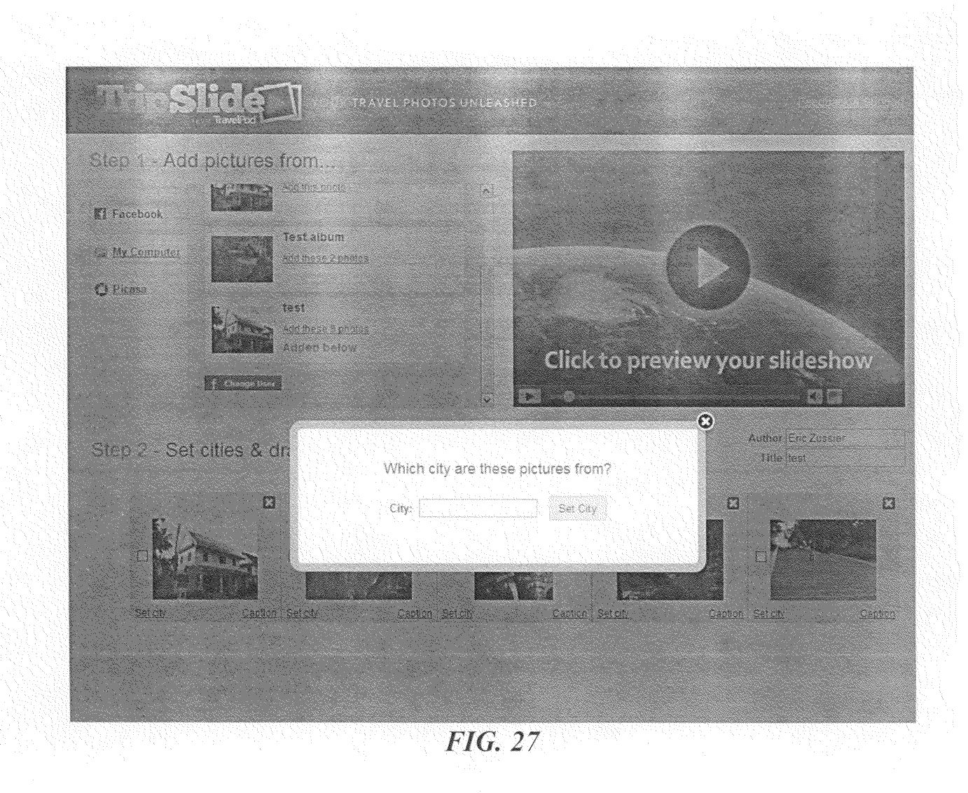

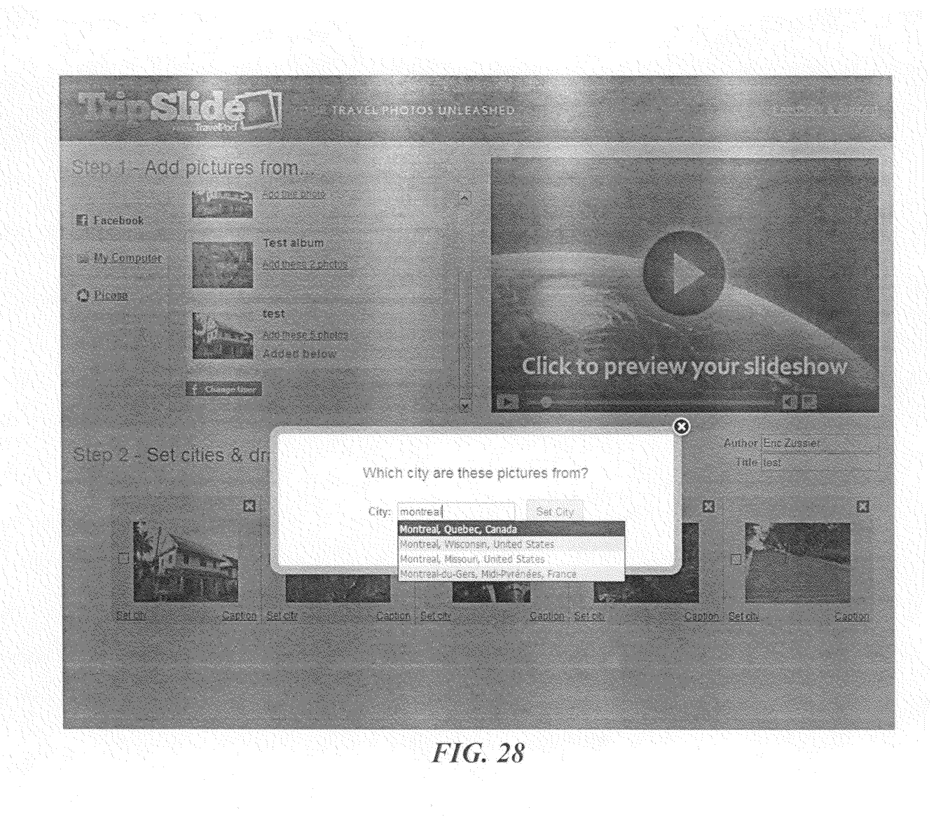

FIG. 27 is a screenshot illustrating requesting the user to identify at which geographical location one or more photographs were taken. FIG. 28 is a screenshot illustrating auto completion of geographical locations.

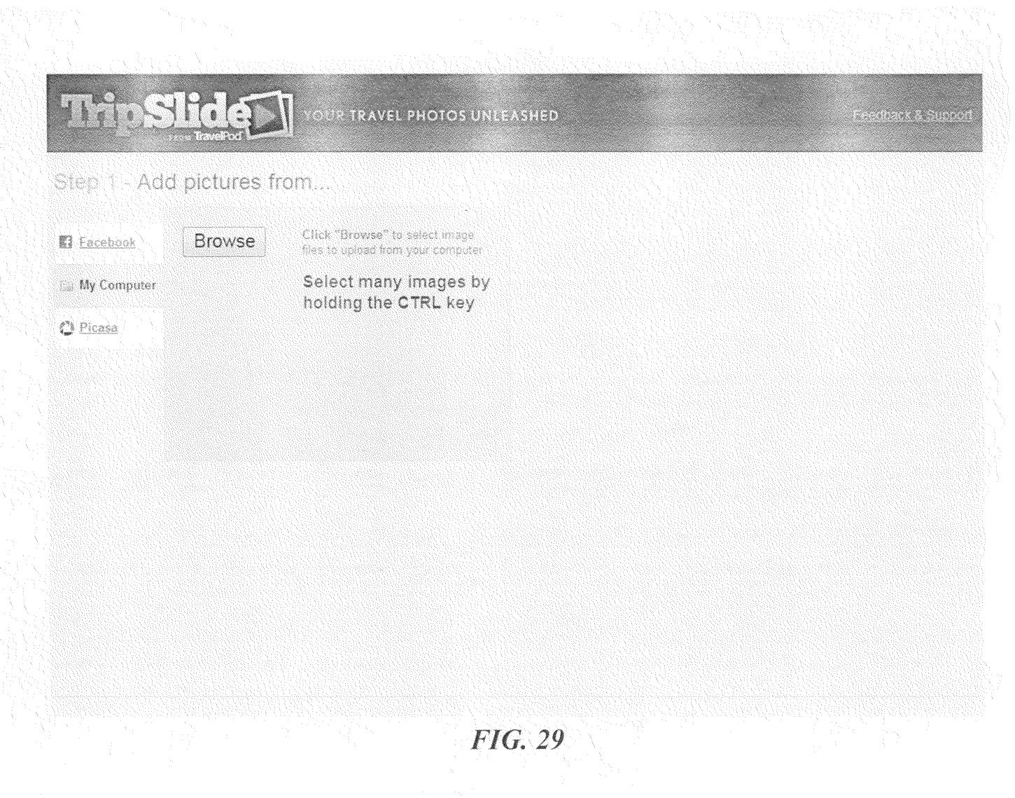

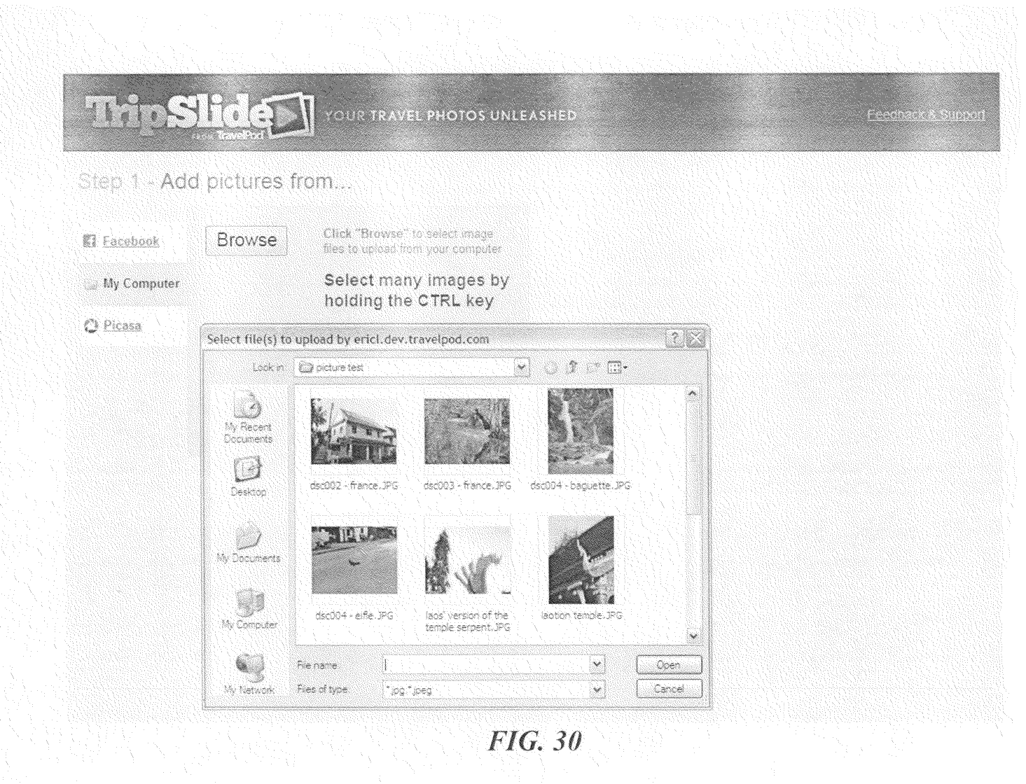

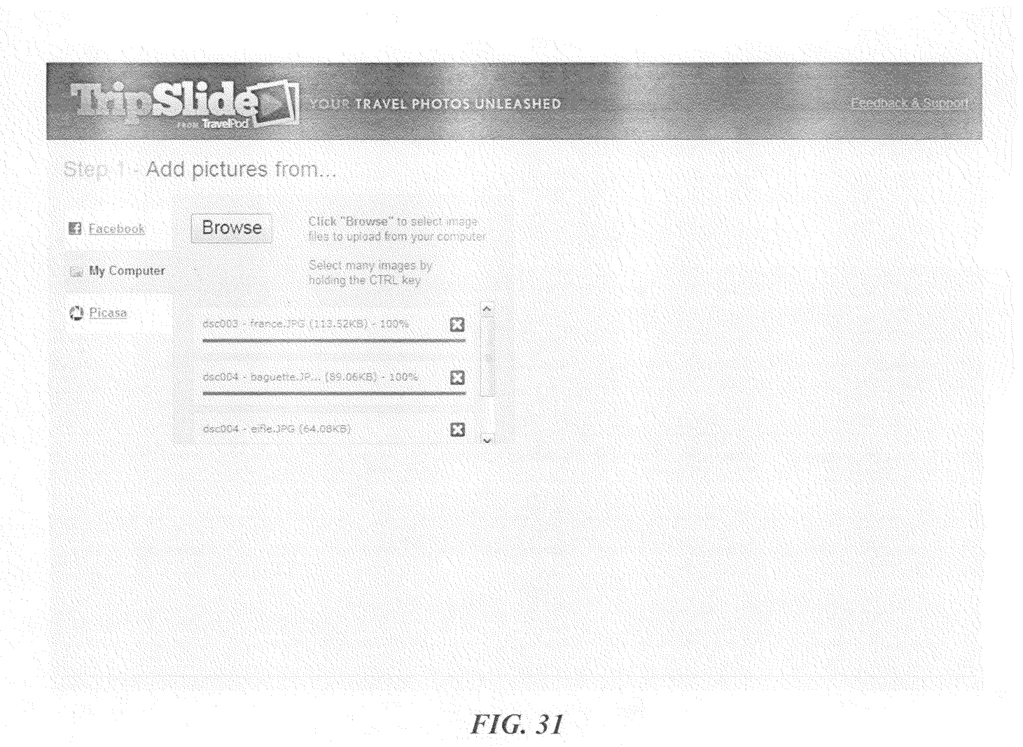

FIG. 29 is a screenshot illustrating enabling the user to add photographs from a local storage device. FIGS. 30 and 31 are screenshots illustrating enabling the user to select photographs from the local storage.

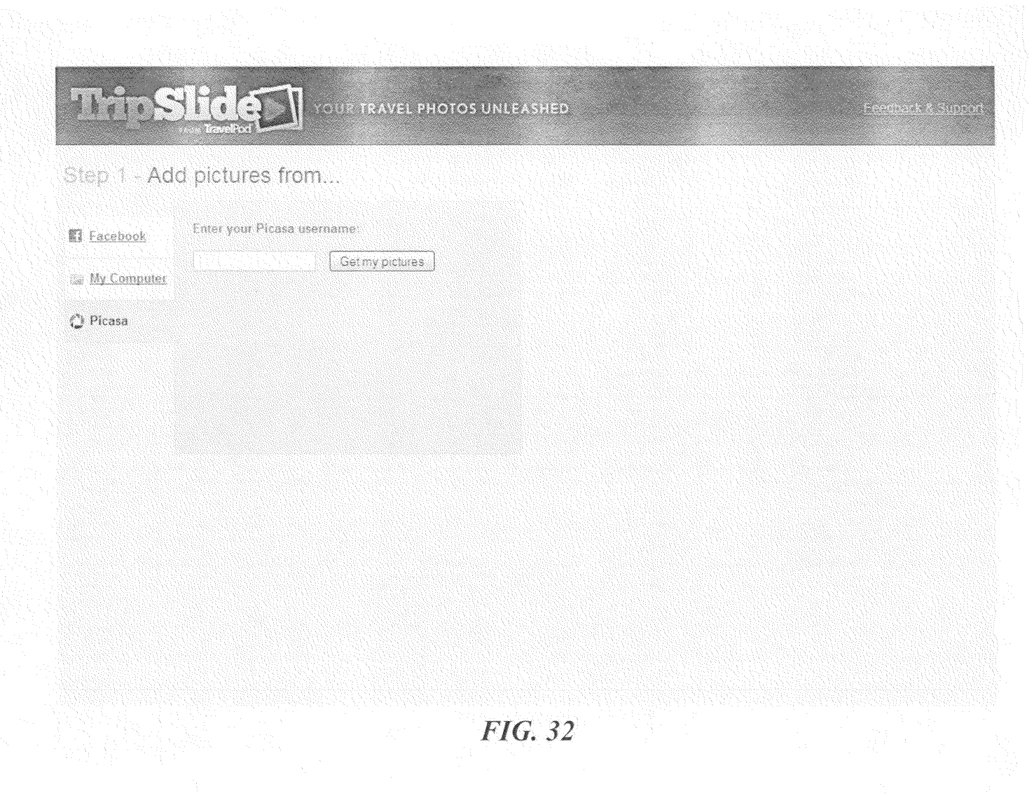

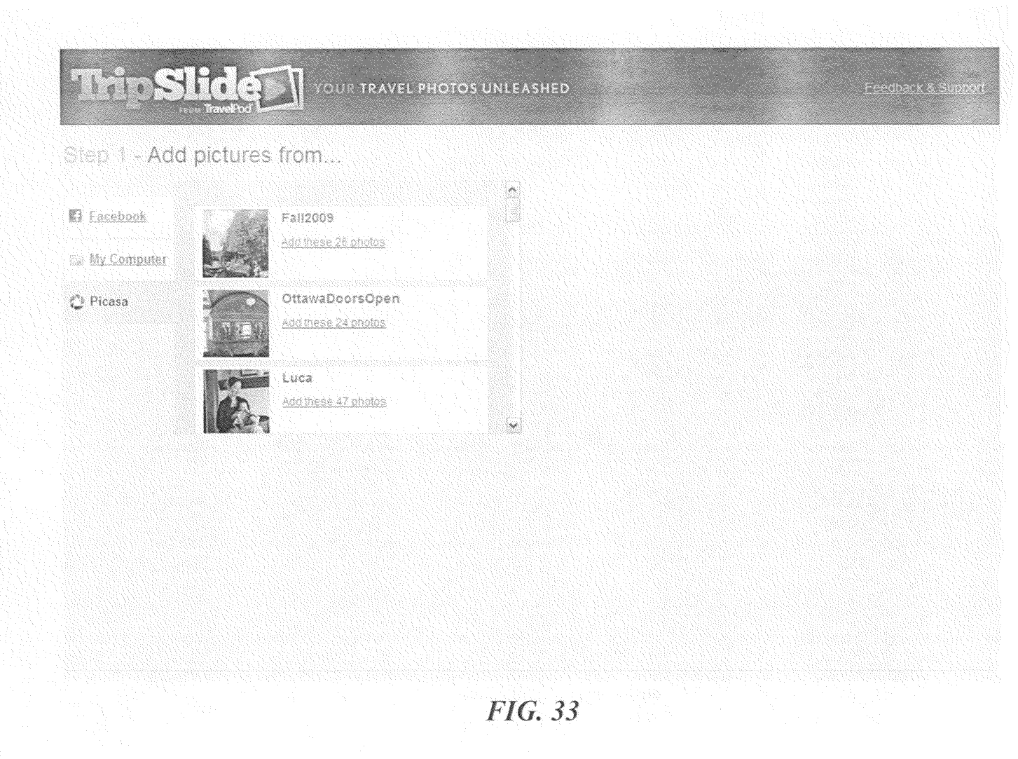

FIGS. 32 and 33 are screenshots illustrating enabling the user to select photographs from an online photograph sharing website.

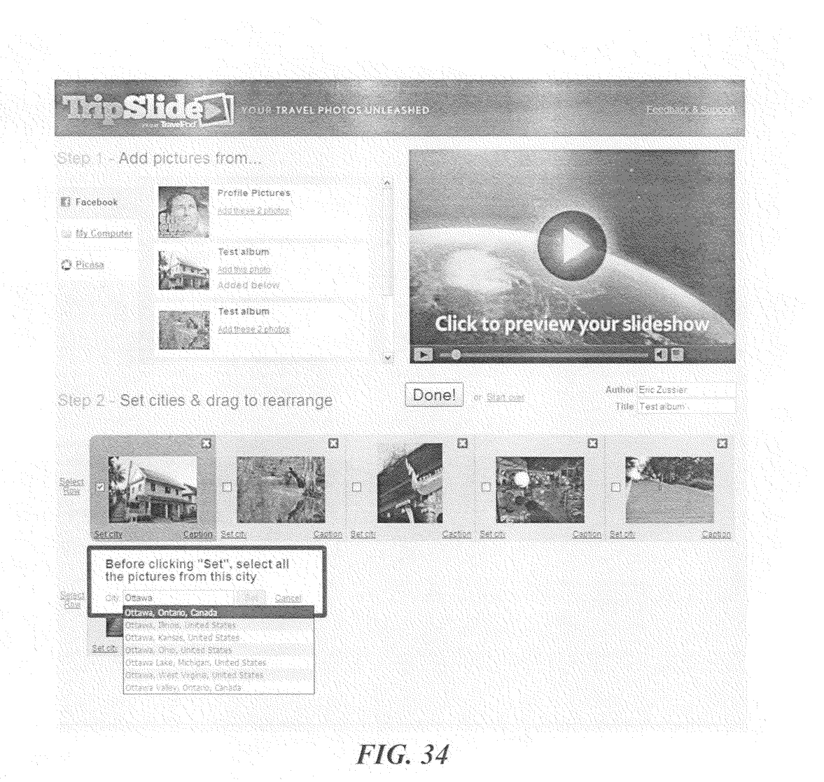

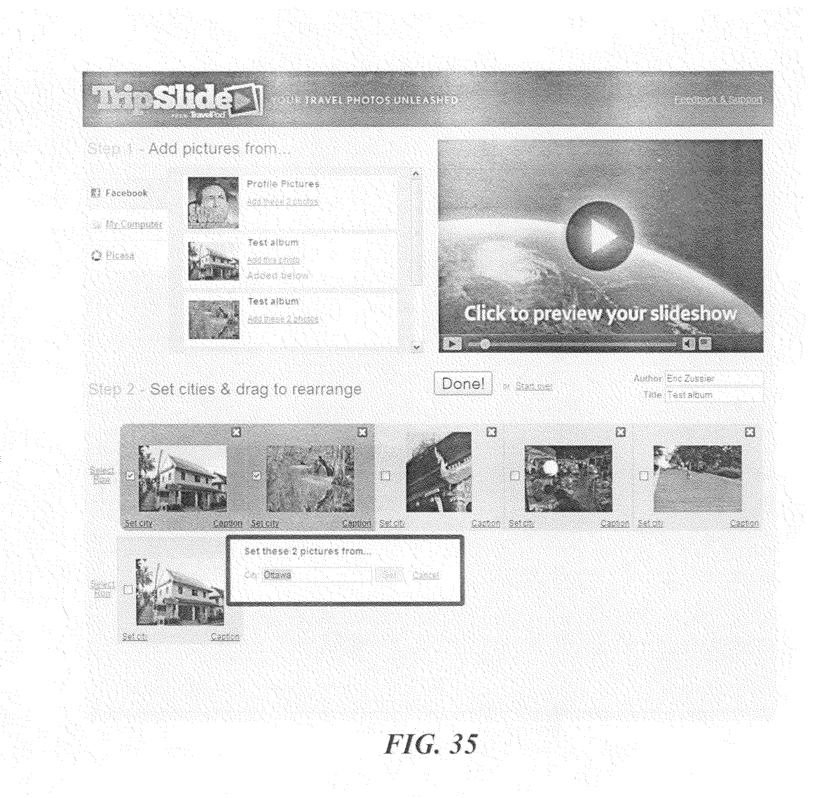

FIG. 34 is a screenshot illustrating enabling the user to select photographs that were taken at a specified geographical location. As an example, the technology may enable the user to select photographs that were previously specified as having been taken at a particular geographical location e.g., by evaluating meta-tags associated with such photographs. FIG. 35 is a screenshot illustrating causing photographs associated with the specified geographical location to be highlighted.

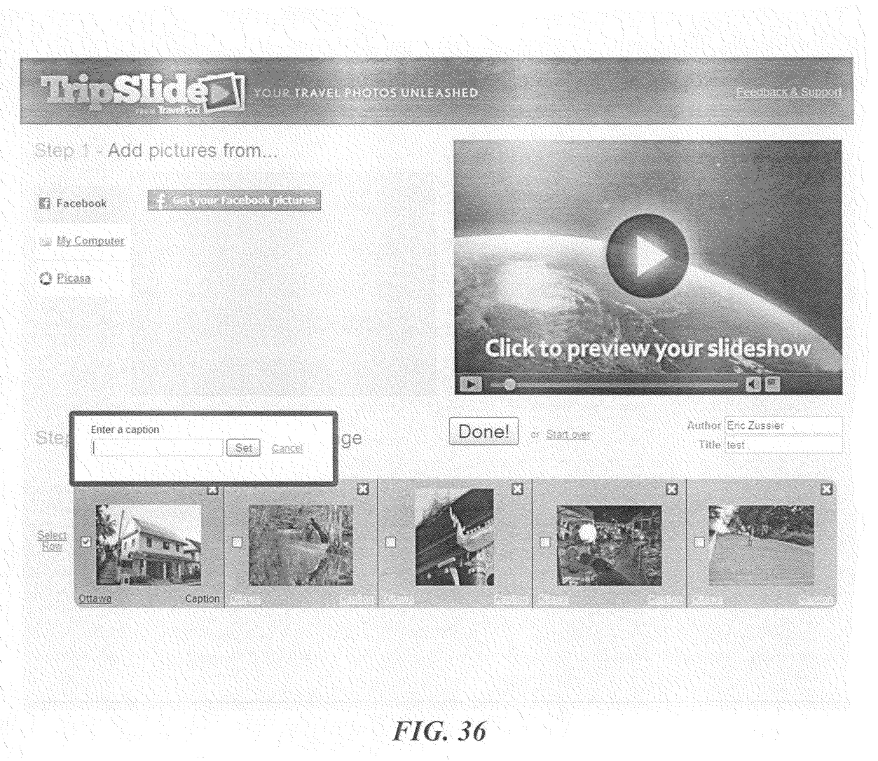

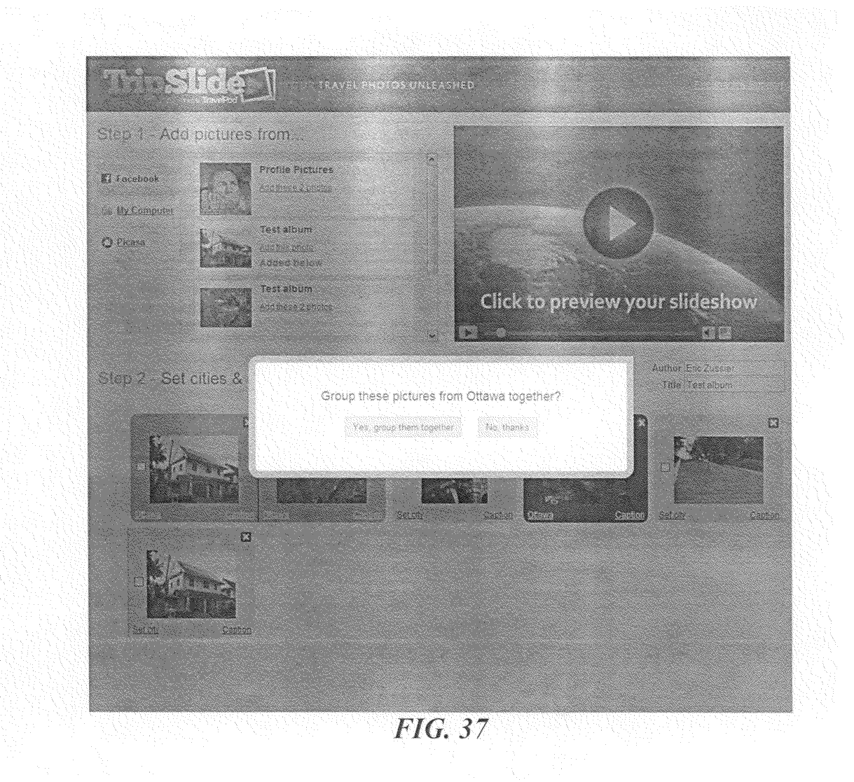

FIG. 36 is a screenshot illustrating enabling the user to provide captions for slides. FIG. 37 is a screenshot illustrating requesting the user to indicate whether multiple photographs associated with a specified geographical location or to be grouped together. As an example, the technology may group together multiple photographs in a single slide or a set of slides. Alternatively, the technology may place individual photographs in different slides. A user can specify which photographs to group together.

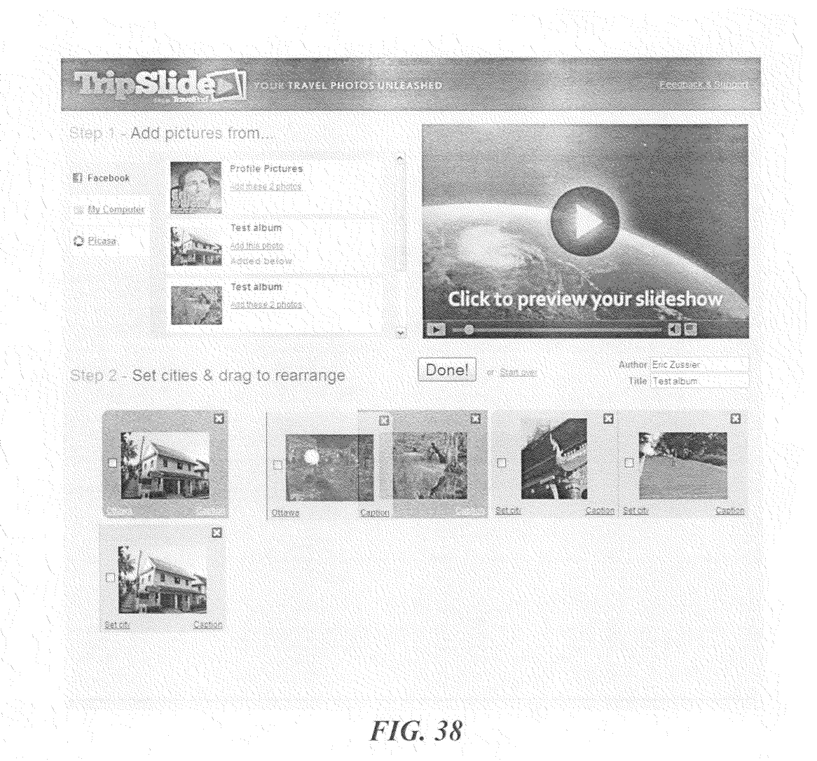

FIG. 38 is a screenshot illustrating enabling the user to specify an ordering for the photographs or slides. The user may be able to drag photographs for slides to rearrange the ordering.

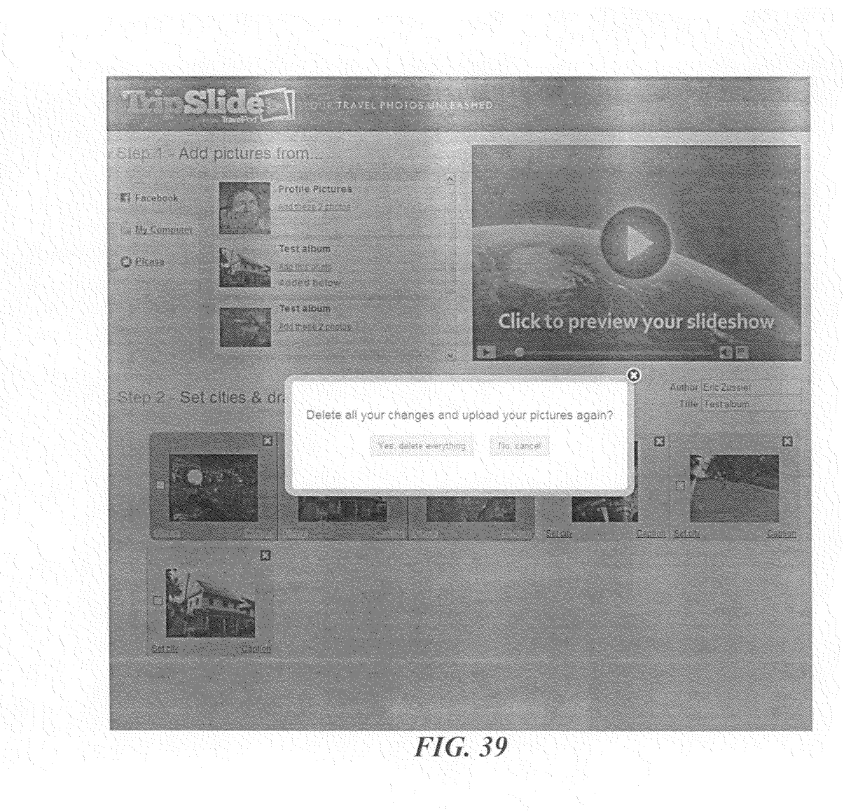

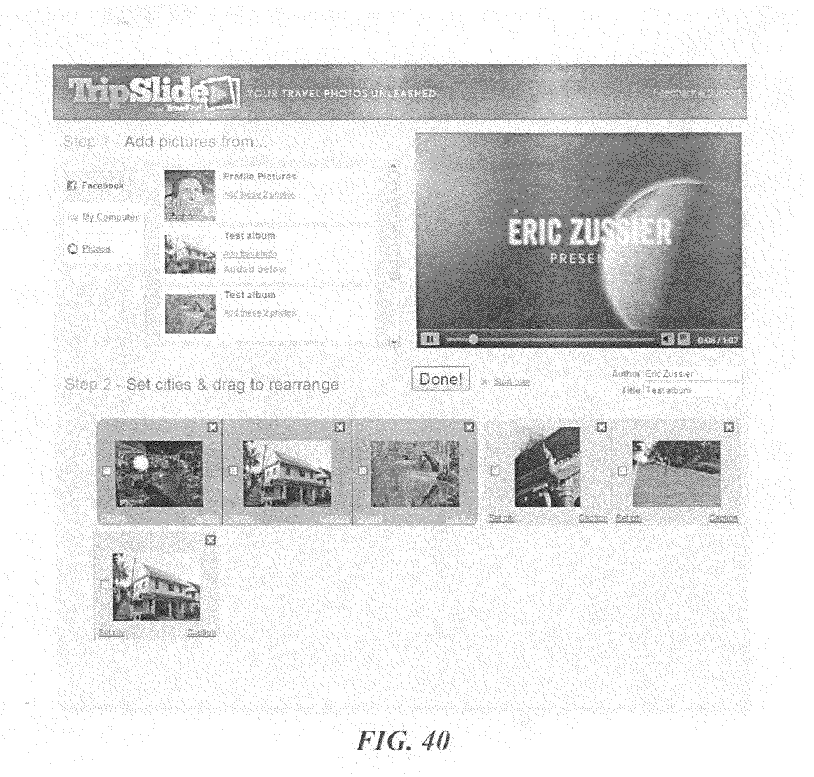

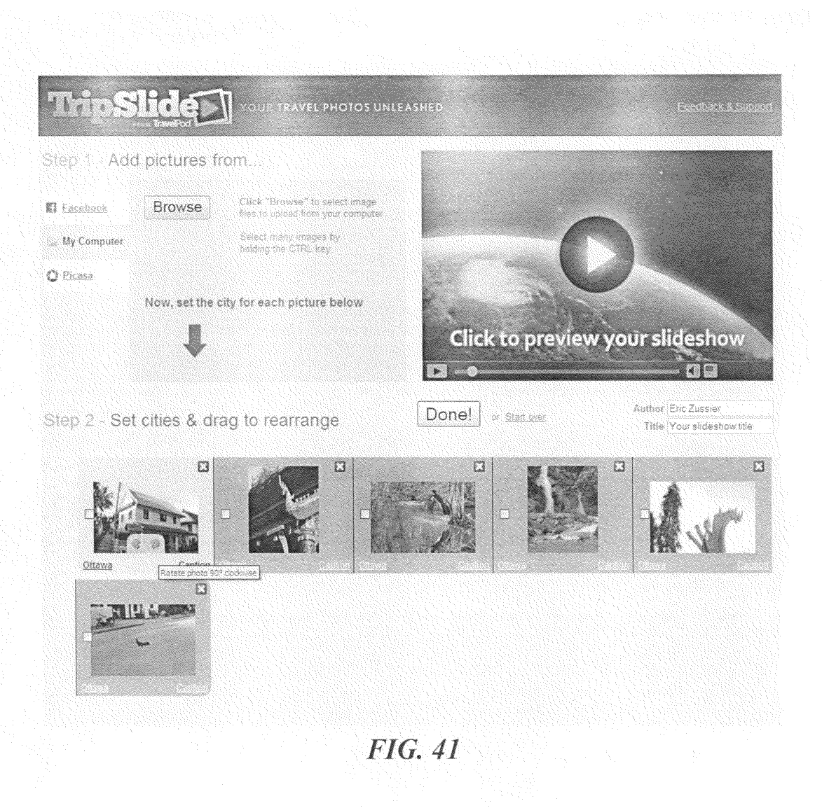

FIG. 39 is a screenshot illustrating enabling the user to create a slideshow anew. FIG. 40 is a screenshot illustrating enabling the user to preview their slideshow during the edit process. FIG. 41 is a screenshot illustrating enabling the user to rotate pictures.

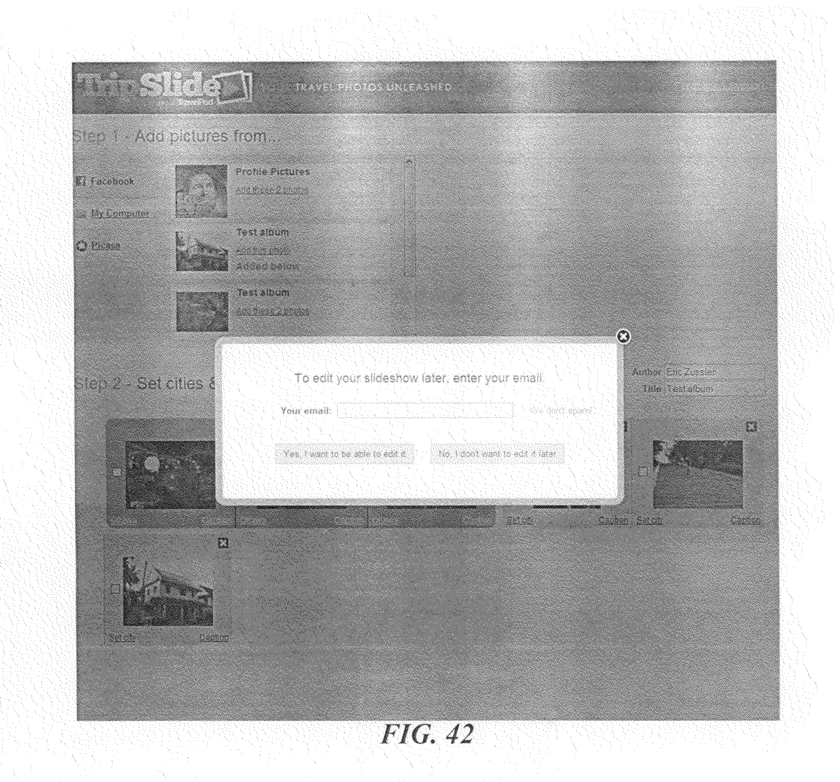

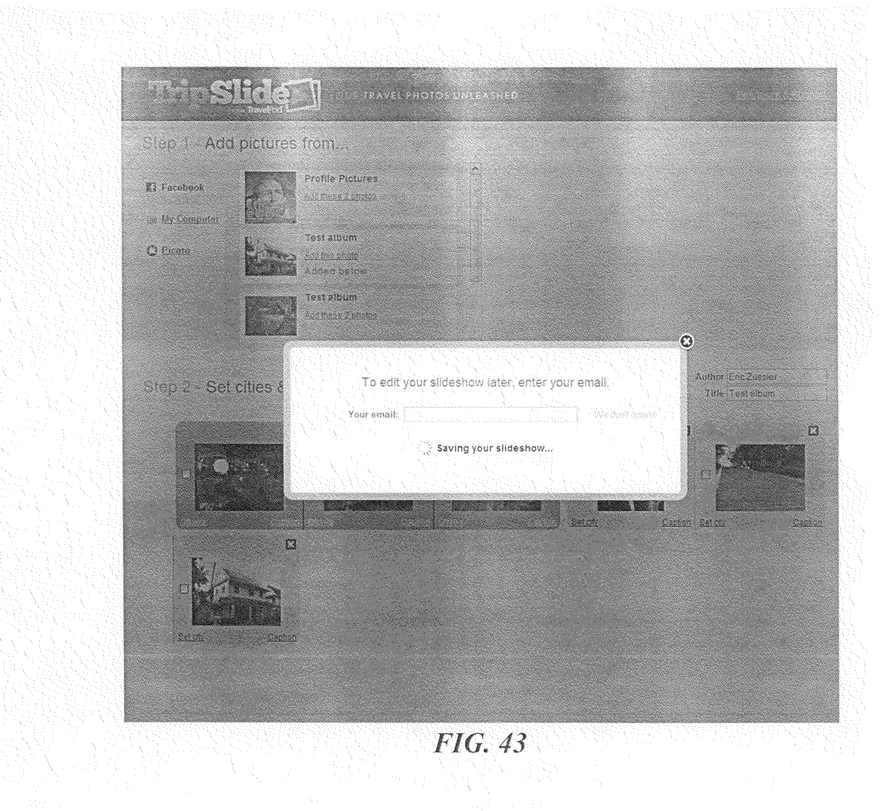

FIGS. 42-43 are screenshots illustrating enabling a user to edit slideshows later. As an example, even though user does not have an account with the system, the user may be able to provide an e-mail address so that the system can transmit a link to the slideshow. When the user subsequently selects the link, the system may be able to enable the user to continue working on the slideshow. As is discussed above and below, the user may be required to provide an email address or other credentials to save and later modify their slideshows in some embodiments.

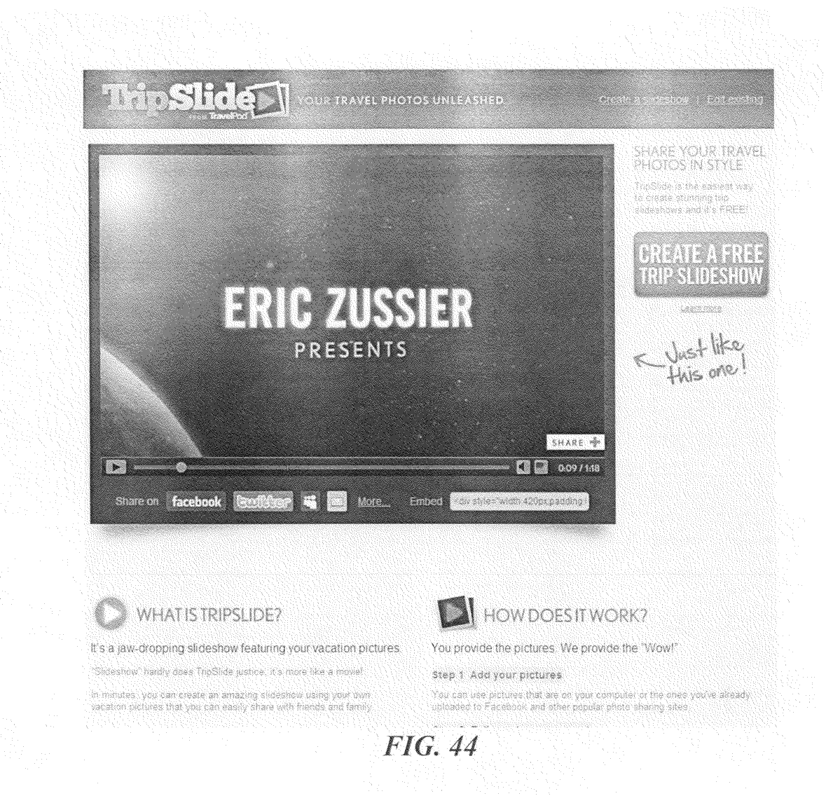

FIG. 44 illustrates a screenshot that a user may see when the user receives a link to a slideshow from another user who has shared the link. The screen enables the technology to “virally” market the technology.

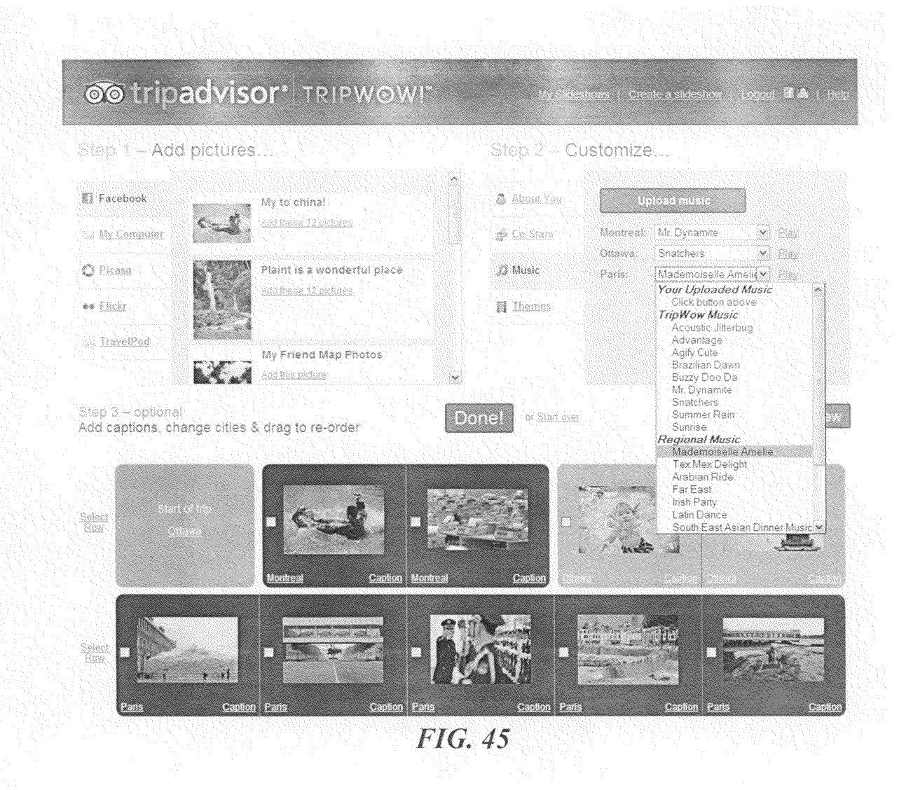

FIG. 45 is a screenshot illustrating a music selection feature with regional geo targeted songs. The technology may identify a sequence of cities that the user has visited (e.g., as identified by the user or automatically determined from geotags associated with the uploaded photographs); and then the user may select songs associated with each visited city. Alternatively, the user may upload songs. The technology can play the selected or uploaded songs when a user subsequently views the slideshow. As an example, when the viewing user views a photograph associated with a city, the technology may play the song selected or uploaded for that city. If the user changes the city for a photograph, a new music selection box may appear for that city. If the city matches a predefined region, the technology may automatically select a song. Uploaded songs may be added to the list of music available for selection by the user.

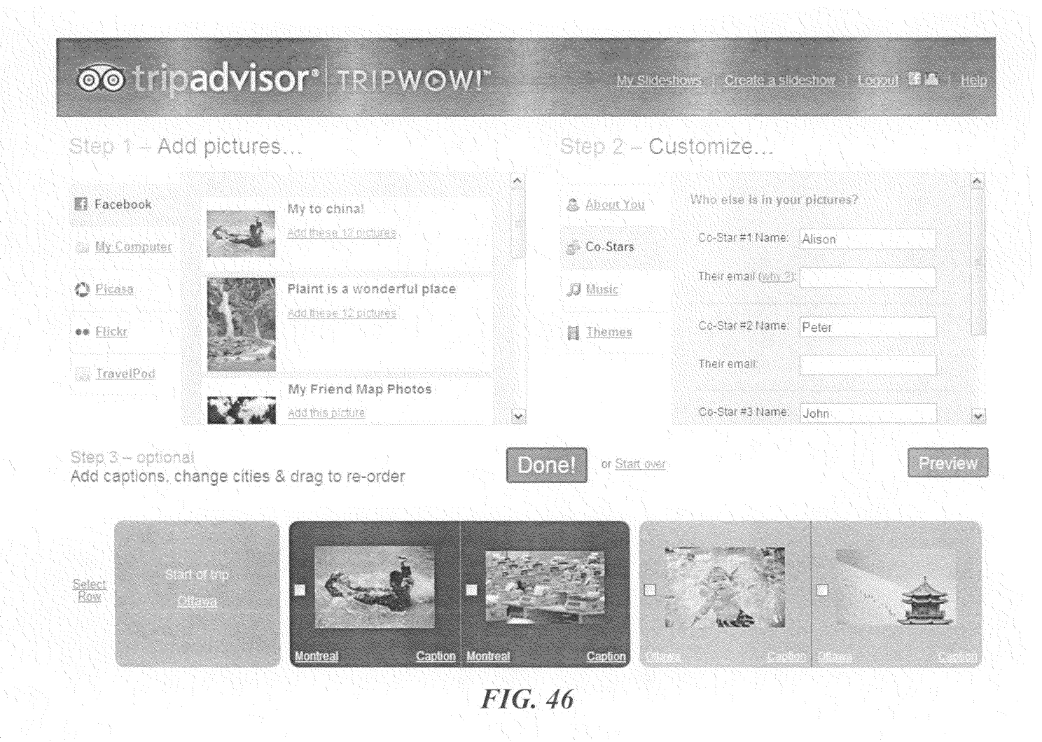

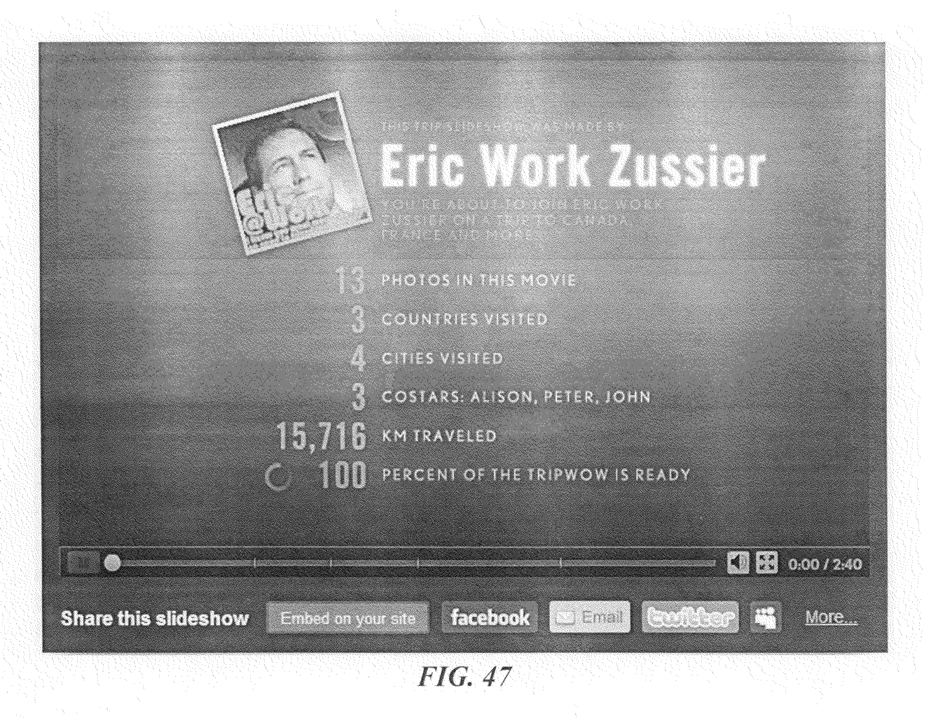

In some embodiments, the technology enables a user to assemble the slideshows as a movie. As an example, the movie may include “stars” and “costars” comprising the people who may be identifiable in the photographs included with the slideshow. FIGS. 46 and 47 are screenshots illustrating such a feature. A user may provide names of “stars” and “costars” using the user interface illustrated in FIG. 46. The user has begun to type in Alison. As illustrated in FIG. 47, the technology may include the provided names (e.g., Eric Zussier) in an “opening sequence” or introductory sequence of the movie.

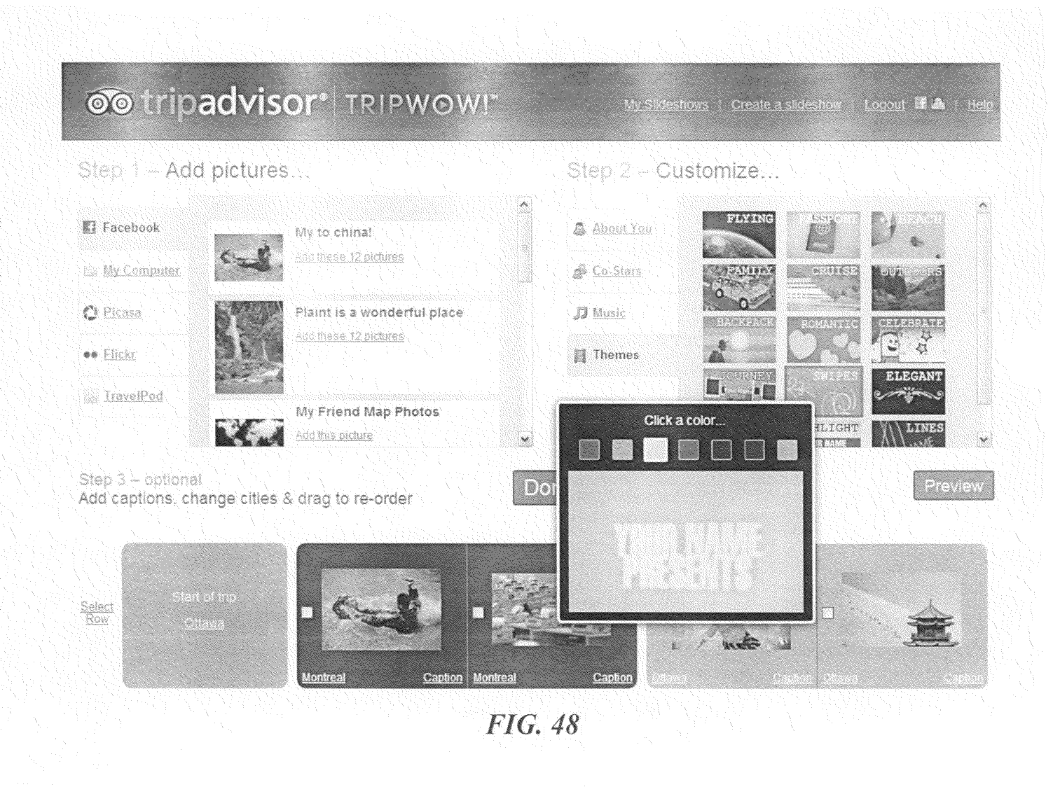

In some embodiments, the technology enables the user to select templates or themes. As an example, FIG. 48 is a screenshot illustrating a template (or “theme”) picker.

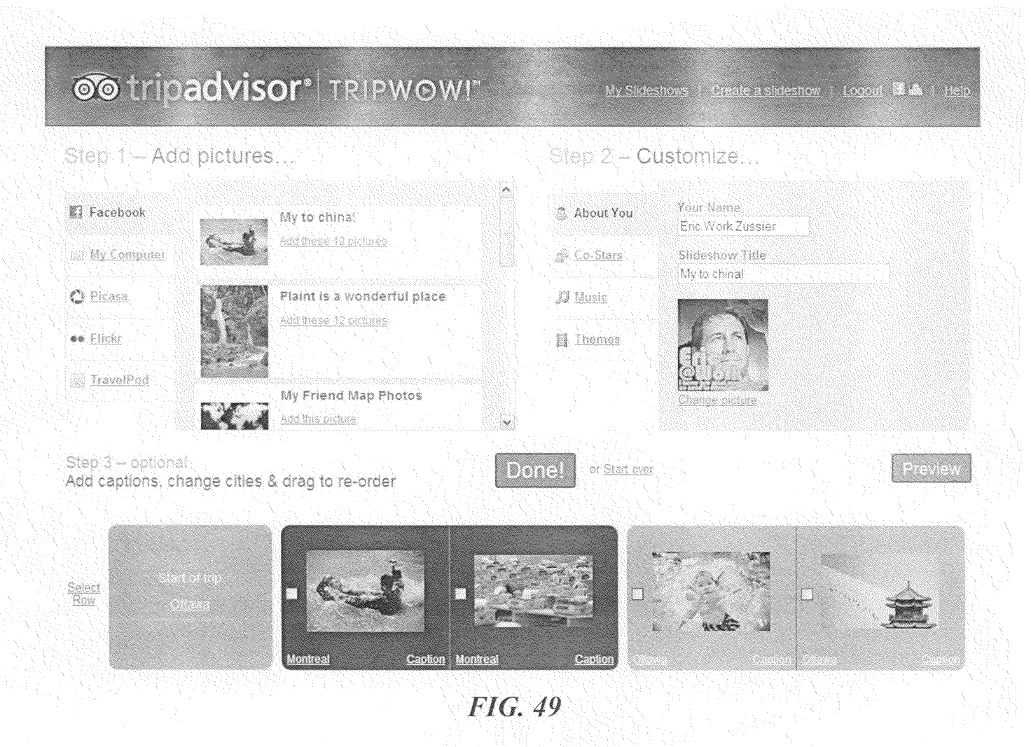

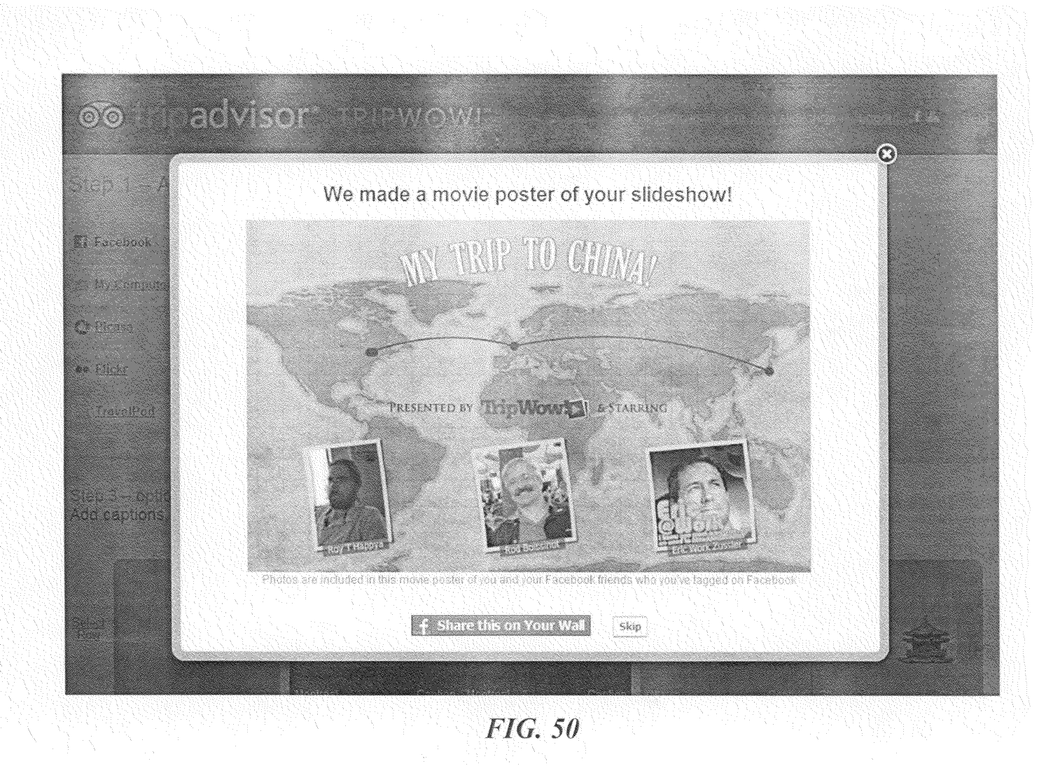

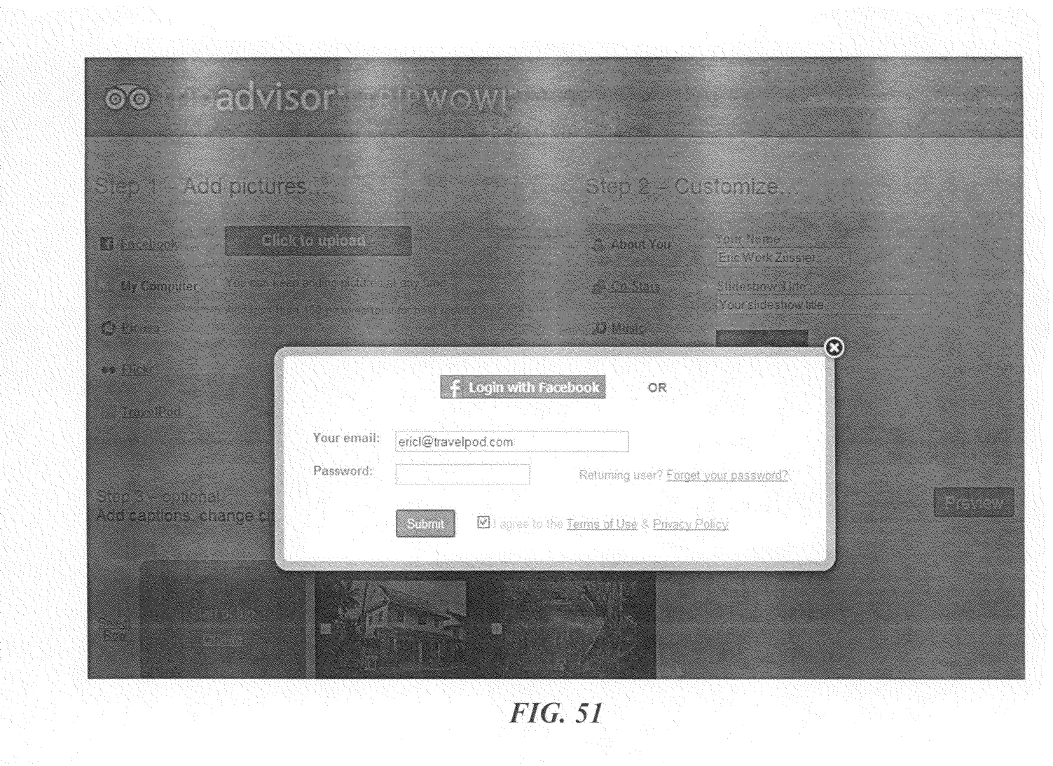

FIG. 49 is a screenshot illustrating enabling a user to personalize a template, e.g., by providing a name, a title, a profile photograph, etc. The technology may use the template in introductory sequences of slideshows.

In some embodiments, the technology may create a “costar poster.” A costar poster is a movie-poster-like slide that the technology may create. As an example, when the user who is creating a slideshow imports photographs from a social networking website, the photographs may be “tagged” with identifications of people and/or objects. The technology can create the costar poster by importing information associated with these tags when the corresponding photograph is added to a slideshow. As an example, after the user has saved their slideshow, the technology may import user's friends' FACEBOOK profile photograph, their name, etc., and put them together with a map that includes all the cities specified in slideshow and the slideshow title. The user who created the slideshow is then offered an option to share the poster on FACEBOOK.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the disclosure is not limited except as by the appended claims.

We claim:

1. A method performed by a computing device, comprising:
receiving at a server computing device, from a first client computing device, a request to create a slideshow;
receiving from the first client computing device an indication of a location of two or more content elements;
retrieving from the indicated location the two or more content elements;
identifying geographical locations associated with each of the retrieved two or more content elements;
creating a map visually identifying at least the geographical locations associated with each of the retrieved two or more content elements;
creating a slideshow containing the retrieved two or more content elements, the created map, and at least one transition; and
transmitting a pointer to the created slideshow.

2. The method of claim 1 further comprising receiving a request to provide the slideshow, wherein the request is received from a second client computing device that is not the first client computing device, and transmitting the created slideshow to the second client computing device.

3. The method of claim 1, wherein the content elements include at least a photograph or a video.

4. The method of claim 1, wherein the location of the two or more content elements is at least one of: a local storage at the first client computing device, a photo sharing website, or a social networking web site.

5. The method of claim 1, wherein the at least one transition includes a professionally created cinematic element.

6. The method of claim 1, wherein the map includes a pushpin visual element for at least one geographical location associated with the retrieved content elements.

7. The method of claim 6, wherein the geographical locations are specified by a user.

8. The method of claim 6, wherein the geographical locations are identified from meta-data associated with the retrieved content elements.

9. The method of claim 1 further comprising automatically adding at least one music element to the created slideshow, wherein the music element is based on music from at least one of the geographical locations.

10. A computer-readable storage device storing computer-executable instructions, the instructions comprising:
receiving at a server computing device, from a first client computing device, a request to create a slideshow;
receiving from the first client computing device an indication of a location of two or more content elements;
retrieving from the indicated location the two or more content elements;
identifying geographical locations associated with each of the retrieved two or more content elements;
creating a slideshow containing the retrieved two or more content elements and at least one transition; and
transmitting a pointer to the created slideshow.

11. The computer-readable medium of claim 10 further comprising enabling a user to edit the created slideshow based on providing a link to the slideshow, but without requiring the user to register.

12. The computer-readable medium of claim 10 further comprising:
identifying a friend of a user who submitted the request to create the slideshow, the friend identifiable at a social networking website;
retrieving a photograph of the friend from the social networking website;
and adding the retrieved photograph of the friend to the slideshow.

13. A system, comprising:
a processor and memory;
a component configured to receive from a first client computing device, a request to create a slideshow;
a component configured to receive from the first client computing device an indication of a location of two or more content elements;
a component configured to retrieve from the indicated location the two or more content elements;
a component configured to identify geographical locations associated with each of the retrieved two or more content elements;
a component configured to create a slideshow containing the retrieved two or more content elements and at least one transition; and
a component configured to transmit a pointer to the created slideshow.

14. The system of claim 13 further comprising a component configured to automatically add a music element to the created slideshow based at least on one of the identified geographical locations.

15. The system of claim 13 further comprising a component configured to create a navigational slider, wherein the slider indicates a sequence of geographical locations in such a manner that a viewer can slide a slider to a particular geographical location in the sequence of geographical locations and doing so causes display of content elements associated with the particular geographical location.
